(19) United States
(12) Patent Application Publication
(10) Pub. No.: US 2026/0046936 A1
(43) Pub. Date: Feb. 12, 2026

(54) IDENTIFYING RANDOM ACCESS OCCASIONS FOR USER EQUIPMENT-SPECIFIC RANDOM ACCESS CONFIGURATIONS IN SUBBAND FULL DUPLEX SYMBOLS

(71) Applicant: QUALCOMM Incorporated, San Diego, CA (US)

(72) Inventors: Ahmed Attia ABOTABL, San Diego, CA (US); Chiranjib SAHA, Lakeside, CA (US); Muhammad Sayed Khairy ABDELGHAFFAR, San Jose, CA (US)

(21) Appl. No.: 19/245,113

(22) Filed: Jun. 20, 2025

Related U.S. Application Data
(60) Provisional application No. 63/679,737, filed on Aug. 6, 2024.

(51) Int. Cl. H04W 74/0833; H04L 5/14

(52) U.S. Cl. CPC H04W 74/0833; H04L 5/14

(57) ABSTRACT

Methods, systems, and devices for wireless communications are described. A use equipment (UE) may receive one or more UE-specific random access configurations associated with random access-triggering events. The one or more UE-specific random access configurations may also be indicative of a set of random access occasions for random access. The UE may also obtain information that is indicative of whether the UE is to use random access occasions in subband full duplex (SBFD) symbols. Based on obtaining the information, the UE may identify that one or more random access occasions of the set of random access occasions are within a SBFD symbol. The UE may then transmit one or more random access preambles during the one or more random access occasions of the SBFD symbol or during other random access occasions of the set of random access occasions based on the obtained information.

### CROSS REFERENCES

The present application for patent claims the benefit of U.S. Provisional Patent Application No. 63/679,737 by ABOTABL et al., entitled “IDENTIFYING RANDOM ACCESS OCCASIONS FOR USER EQUIPMENT-SPECIFIC RANDOM ACCESS CONFIGURATIONS IN SUBBAND FULL DUPLEX SYMBOLS,” filed Aug. 6, 2024, assigned to the assignee hereof, and expressly incorporated by reference in its entirety herein.

### FIELD OF TECHNOLOGY

The following relates to wireless communications, including identifying random access occasions for user equipment (UE)-specific random access configurations in subband full duplex (SBFD) symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more UE-specific random access configurations each associated with respective random access-triggering events, the one or more UE-specific random access configurations each indicative of a set of multiple random access occasions for random access, obtaining information that is indicative of whether the UE is to use random access occasions in subband full duplex (SBFD) symbols, and transmitting one or more random access preambles during one or more random access occasions of a SBFD symbol or during other random access occasions of the set of multiple random access occasions based on the information.

A UE for wireless communications is described. The UE may include one or more memories storing processor executable code, and one or more processors coupled with the one or more memories. The one or more processors may individually or collectively be operable to execute the code to cause the UE to receive one or more UE-specific random access configurations each associated with respective random access-triggering events, the one or more UE-specific random access configurations each indicative of a set of multiple random access occasions for random access, obtain information that is indicative of whether the UE is to use random access occasions in SBFD symbols, and transmit one or more random access preambles during one or more random access occasions of an SBFD symbol or during other random access occasions of the set of multiple random access occasions based on the information.

Another UE for wireless communications is described. The UE may include means for receiving one or more UE-specific random access configurations each associated with respective random access-triggering events, the one or more UE-specific random access configurations each indicative of a set of multiple random access occasions for random access, means for obtaining information that is indicative of whether the UE is to use random access occasions in SBFD symbols, and means for transmitting one or more random access preambles during one or more random access occasions of a SBFD symbol or during other random access occasions of the set of multiple random access occasions based on the information.

A non-transitory computer-readable medium storing code for wireless communications is described. The code may include instructions executable by one or more processors to receive one or more UE-specific random access configurations each associated with respective random access-triggering events, the one or more UE-specific random access configurations each indicative of a set of multiple random access occasions for random access, obtain information that is indicative of whether the UE is to use random access occasions in SBFD symbols, and transmit one or more random access preambles during one or more random access occasions of a SBFD symbol or during other random access occasions of the set of multiple random access occasions based on the information.

Some examples of the method, UEs, and non-transitory computer-readable medium described herein may further include operations, features, means, or instructions for receiving, via a control message, the information that may be indicative of whether the UE may be configured to use the random access occasions in the SBFD symbols, where obtaining the information may be based on receiving the control message.

In some examples of the method, UEs, and non-transitory computer-readable medium described herein, the control message includes a parameter whose value may be a configuration index that indicates the information.

In some examples of the method, UEs, and non-transitory computer-readable medium described herein, the control message indicates that the UE may be not configured (e.g., unable) to use the random access occasions in the SBFD symbols based on an absence, in the control message, of a parameter whose value may be a configuration index that, when present, indicates the information.

In some examples of the method, UEs, and non-transitory computer-readable medium described herein, the control message may be a radio resource control (RRC) message.

In some examples of the method, UEs, and non-transitory computer-readable medium described herein, obtaining the information may include operations, features, means, or instructions for obtaining an indication to use a random access occasion identification configuration from a set of multiple random access occasion identification configurations, the set of multiple random access occasion identification configurations including a first random access occasion identification configuration for identifying only the other random access occasions of the set of multiple random access occasions, a second random access occasion identification configuration for identifying the other random access occasions of the set of multiple random access occasions and the one or more random access occasions of the SBFD symbol, and a third random access occasion identification configuration for identifying only the one or more random access occasions of the SBFD symbol.

In some examples of the method, UEs, and non-transitory computer-readable medium described herein, the one or more UE-specific random access configurations associated with the respective random access-triggering events include an indication of a default random access occasion identification configuration from the set of multiple random access occasion identification configurations.

In some examples of the method, UEs, and non-transitory computer-readable medium described herein, obtaining the information may include operations, features, means, or instructions for obtaining, via the information, an indication that the UE may be configured to use the random access occasions in the SBFD symbols.

Some examples of the method, UEs, and non-transitory computer-readable medium described herein may further include operations, features, means, or instructions for refraining from transmitting the one or more random access preambles during the other random access occasions of the set of multiple random access occasions based on obtaining the indication via the information, where the one or more random access preambles may be transmitted only during the one or more random access occasions of the SBFD symbol based on obtaining the indication via the information.

Some examples of the method, UEs, and non-transitory computer-readable medium described herein may further include operations, features, means, or instructions for receiving a control message that indicates a reference signal prioritization, where the one or more random access preambles may be transmitted during the one or more random access occasions of the SBFD symbol or during the other random access occasions of the set of multiple random access occasions based on the reference signal prioritization and on obtaining the indication via the information.

Some examples of the method, UEs, and non-transitory computer-readable medium described herein may further include operations, features, means, or instructions for selecting, based at least in part on the UE satisfying one or more thresholds, the one or more random access occasions of the SBFD symbol and transmitting the one or more random access preambles only during the one or more random access occasions of the SBFD symbol based on the UE selecting the one or more random access occasions and on obtaining the indication via the information.

In some examples of the method, UEs, and non-transitory computer-readable medium described herein, the one or more thresholds include a reference signal received power (RSRP) threshold, a transmission power threshold, or a combination thereof.

In some examples of the method, UEs, and non-transitory computer-readable medium described herein, obtaining the information may include operations, features, means, or instructions for identifying that the information of whether the UE may be configured to use the random access occasions in the SBFD symbols may be associated with a subset of UE-specific random access configurations of the one or more UE-specific random access configurations.

Some examples of the method, UEs, and non-transitory computer-readable medium described herein may further include operations, features, means, or instructions for receiving, via a bit of a control message, the information that may be indicative of whether the UE may be configured to use the random access occasions in the SBFD symbols, the bit of the control message including an indication of the information, where obtaining the information may be based on receiving the control message, and where the control message is triggered via a control channel order.

Some examples of the method, UEs, and non-transitory computer-readable medium described herein may further include operations, features, means, or instructions for selecting a random access occasion for transmitting the one or more random access preambles, where the random access occasion may be selected from a pool of respective random access occasions that may be available for transmission of the one or more random access preambles.

In some examples of the method, UEs, and non-transitory computer-readable medium described herein, the control message may be a downlink control information (DCI) message.

Some examples of the method, UEs, and non-transitory computer-readable medium described herein may further include operations, features, means, or instructions for identifying whether the UE may be configured with a first random access procedure or a second random access procedure, where the information that may be indicative of whether the UE may be configured to use the random access occasions in the SBFD symbols may be obtained based on identifying that the UE may be configured with a respective random access procedure.

In some examples of the method, UEs, and non-transitory computer-readable medium described herein, the first random access procedure may be a contention based random access procedure and the second random access procedure may be a contention free random access procedure.

A method for wireless communications by a network entity is described. The method may include transmitting, to a UE, one or more UE-specific random access configurations each associated with respective random access-triggering events, the one or more UE-specific random access configurations each indicative of a set of multiple random access occasions for random access, transmitting, to the UE, information that is indicative of whether the UE is to use random access occasions in SBFD symbols, and receiving, from the UE, one or more random access preambles during one or more random access occasions of a SBFD symbol or during other random access occasions of the set of multiple random access occasions based on whether the UE is to use the random access occasions in the SBFD symbols.

A network entity for wireless communications is described. The network entity may include one or more memories storing processor executable code, and one or more processors coupled with the one or more memories. The one or more processors may individually or collectively be operable to execute the code to cause the network entity to transmit, to a UE, one or more UE-specific random access configurations each associated with respective random access-triggering events, the one or more UE-specific random access configurations each indicative of a set of multiple random access occasions for random access, transmit, to the UE, information that is indicative of whether the UE is to use random access occasions in SBFD symbols, and receive, from the UE, one or more random access preambles during one or more random access occasions of a SBFD symbol or during other random access occasions of the set of multiple random access occasions based on whether the UE is to use the random access occasions in the SBFD symbols.

Another network entity for wireless communications is described. The network entity may include means for transmitting, to a UE, one or more UE-specific random access configurations each associated with respective random access-triggering events, the one or more UE-specific random access configurations each indicative of a set of multiple random access occasions for random access, means for transmitting, to the UE, information that is indicative of whether the UE is to use random access occasions in SBFD symbols, and means for receiving, from the UE, one or more random access preambles during one or more random access occasions of a SBFD symbol or during other random access occasions of the set of multiple random access occasions based on whether the UE is to use the random access occasions in the SBFD symbols.

A non-transitory computer-readable medium storing code for wireless communications is described. The code may include instructions executable by one or more processors to transmit, to a UE, one or more UE-specific random access configurations each associated with respective random access-triggering events, the one or more UE-specific random access configurations each indicative of a set of multiple random access occasions for random access, transmit, to the UE, information that is indicative of whether the UE is to use random access occasions in SBFD symbols, and receive, from the UE, one or more random access preambles during one or more random access occasions of a SBFD symbol or during other random access occasions of the set of multiple random access occasions based on whether the UE is to use the random access occasions in the SBFD symbols.

Some examples of the method, network entities, and non-transitory computer-readable medium described herein may further include operations, features, means, or instructions for transmitting, to the UE via a control message, the information that may be indicative of whether the UE may be configured to use the random access occasions in the SBFD symbols, where the one or more random access preambles may be received during the one or more random access occasions of the SBFD symbol based on transmitting the control message.

In some examples of the method, network entities, and non-transitory computer-readable medium described herein, the control message includes a parameter whose value may be a configuration index that indicates the information.

In some examples of the method, network entities, and non-transitory computer-readable medium described herein, the control message indicates that the UE may be not configured to use the random access occasions in the SBFD symbols based on an absence, in the control message, of a parameter whose value may be a configuration index that, when present, indicates the information.

In some examples of the method, network entities, and non-transitory computer-readable medium described herein, the control message may be an RRC message.

In some examples of the method, network entities, and non-transitory computer-readable medium described herein, transmitting the information may include operations, features, means, or instructions for transmitting, to the UE, an indication to use a random access occasion identification configuration from a set of multiple random access occasion identification configurations, the set of multiple random access occasion identification configurations including a first random access occasion identification configuration for identifying only the other random access occasions of the set of multiple random access occasions, a second random access occasion identification configuration for identifying the other random access occasions of the set of multiple random access occasions and the one or more random access occasions of the SBFD symbol, and a third random access occasion identification configuration for identifying only the one or more random access occasions of the SBFD symbol.

In some examples of the method, network entities, and non-transitory computer-readable medium described herein, the one or more UE-specific random access configurations associated with the respective random access-triggering events include an indication of a default random access occasion identification configuration from the set of multiple random access occasion identification configurations.

In some examples of the method, network entities, and non-transitory computer-readable medium described herein, transmitting the information may include operations, features, means, or instructions for transmitting, to the UE, an indication configuring the UE to use the random access occasions in the SBFD symbols.

Some examples of the method, network entities, and non-transitory computer-readable medium described herein may further include operations, features, means, or instructions for receiving, from the UE, the one or more random access preambles only during the one or more random access occasions of the SBFD symbol based on transmitting the indication via the information.

Some examples of the method, network entities, and non-transitory computer-readable medium described herein may further include operations, features, means, or instructions for transmitting, to the UE, a control message that indicates a reference signal prioritization, where the one or more random access preambles may be received during the one or more random access occasions of the SBFD symbol or during the other random access occasions of the set of multiple random access occasions based on transmitting the reference signal prioritization and on transmitting the indication via the information.

Some examples of the method, network entities, and non-transitory computer-readable medium described herein may further include operations, features, means, or instructions for receiving, from the UE, the one or more random access preambles only during the one or more random access occasions of the SBFD symbol based on the UE satisfying one or more thresholds and on transmitting the indication via the information.

In some examples of the method, network entities, and non-transitory computer-readable medium described herein, the one or more thresholds include a RSRP threshold, a transmission power threshold, or a combination thereof.

In some examples of the method, network entities, and non-transitory computer-readable medium described herein, transmitting the information may include operations, features, means, or instructions for transmitting, to the UE, an indication that the information of whether the UE may be configured to use the random access occasions in the SBFD symbols may be associated with a subset of UE-specific random access configurations of the one or more UE-specific random access configurations.

Some examples of the method, network entities, and non-transitory computer-readable medium described herein may further include operations, features, means, or instructions for transmitting, to the UE via a bit of a control message, the information that may be indicative of whether the UE may be configured to use the random access occasions in the SBFD symbols, the bit of the control message including an indication of the information, where transmitting the information may be based on transmitting the control message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 through 3 show an example of a wireless communications system that supports identifying random access occasions for user equipment (UE)-specific random access configurations in subband full duplex (SBFD) symbols in accordance with one or more aspects of the present disclosure.

FIG. 4 shows an example of a process flow that supports identifying random access occasions for UE-specific random access configurations in SBFD symbols in accordance with one or more aspects of the present disclosure.

FIGS. 5 and 6 show block diagrams of devices that support identifying random access occasions for UE-specific random access configurations in SBFD symbols in accordance with one or more aspects of the present disclosure.

FIG. 7 shows a block diagram of a communications manager that supports identifying random access occasions for UE-specific random access configurations in SBFD symbols in accordance with one or more aspects of the present disclosure.

FIG. 8 shows a diagram of a system including a device that supports identifying random access occasions for UE-specific random access configurations in SBFD symbols in accordance with one or more aspects of the present disclosure.

FIGS. 9 and 10 show block diagrams of devices that support identifying random access occasions for UE-specific random access configurations in SBFD symbols in accordance with one or more aspects of the present disclosure.

FIG. 11 shows a block diagram of a communications manager that supports identifying random access occasions for UE-specific random access configurations in SBFD symbols in accordance with one or more aspects of the present disclosure.

FIG. 12 shows a diagram of a system including a device that supports identifying random access occasions for UE-specific random access configurations in SBFD symbols in accordance with one or more aspects of the present disclosure.

FIGS. 13 and 14 show flowcharts illustrating methods that support identifying random access occasions for UE-specific random access configurations in SBFD symbols in accordance with one or more aspects of the present disclosure.

### DETAILED DESCRIPTION

In some wireless communication systems, a network entity may configure user equipments (UEs) with one or more random access configurations. For example, a UE may be configured with UE-specific random access configurations for a UE to initiate connections, perform handovers, perform synchronizations, and the like based on random access triggering events. Moreover, some UEs may be considered SBFD (SBFD) aware UEs and can be capable of identifying random access occasions for transmitting random access preambles within an SBFD symbol. SBFD symbols may be downlink symbols that include uplink resources or subband that the UE may be capable of using for transmitting random access preambles. In some examples, to enable a UE to be able to identify valid random access occasions within SBFD symbols, the UE may utilize a random access occasion identification configuration that is used to identify random access occasions within TDD symbols. A network entity may also configure a UE with an additional random access occasion identification configuration for identifying random access occasions within SBFD symbols.

Thus, a UE may be configured to only identify random access occasions within TDD symbols, to identify random access occasions within TDD symbols and SBFD symbols using the same configuration, or to identify random access within TDD symbols and SBFD symbols using separate configurations. However, a UE may be unable to determine which random access occasion identification configuration the UE should use. For example, based on network conditions or conditions at the UE, using one of the configurations may result in an increase in latency of communication based on the UE not identifying all the possible random access occasions for random access preamble transmissions. In another example, using a respective random access occasion identification procedure may result in an increase in resource communication and can reduce the efficiency, reliability, and accuracy of communications within a wireless communications system.

To ensure reliable and efficient communications, in accordance with the techniques of the present disclosure, a UE may be implicitly or explicitly indicated on how to determine valid random access occasions for random access. For example, a UE may receive a control signal from a network entity that indicates a random access occasion identification procedure that the UE should use. In some cases, the UE may also identify that each UE-random access configuration that the network entity configures for the UE may include a default random access occasion identification procedure. Thus, based on the default configuration or the indication within a control signal the UE may be explicitly configured to identify random access occasions within in TDD symbols only, to identify random access occasions within both TDD symbols and SBFD symbols using a same configuration, or to identify random access occasions within TDD symbols using a first configuration and within SBFD symbols using a second configuration.

In some cases, a UE may identify which random access occasion identification procedure to use implicitly based on identifying a type of random access procedure that the network entity configures the UE with. For example, based on the network entity configuring the UE with a contention-based random access (CBRA) procedure or a contention free random access (CFRA) procedure, the UE may identify an associated random access occasion identification procedure to use. Thus, the techniques of the present disclosure may enable UEs to receive (e.g., implicitly or explicitly) an indication of a random access occasion identification procedure to use. Moreover, such indication may ensure that such random access occasion identification and random access preamble transmission refrains from impacting the efficiency, reliability, and accuracy of communications within a wireless communications system.

Aspects of the disclosure are initially described in the context of wireless communications systems. Additional aspects of the disclosure are described with reference to wireless communications systems and a process flow Aspects of the disclosure are further illustrated by and described with reference to apparatus diagrams, system diagrams, and flowcharts that relate to identifying random access occasions for UE-specific random access configurations in SBFD symbols.

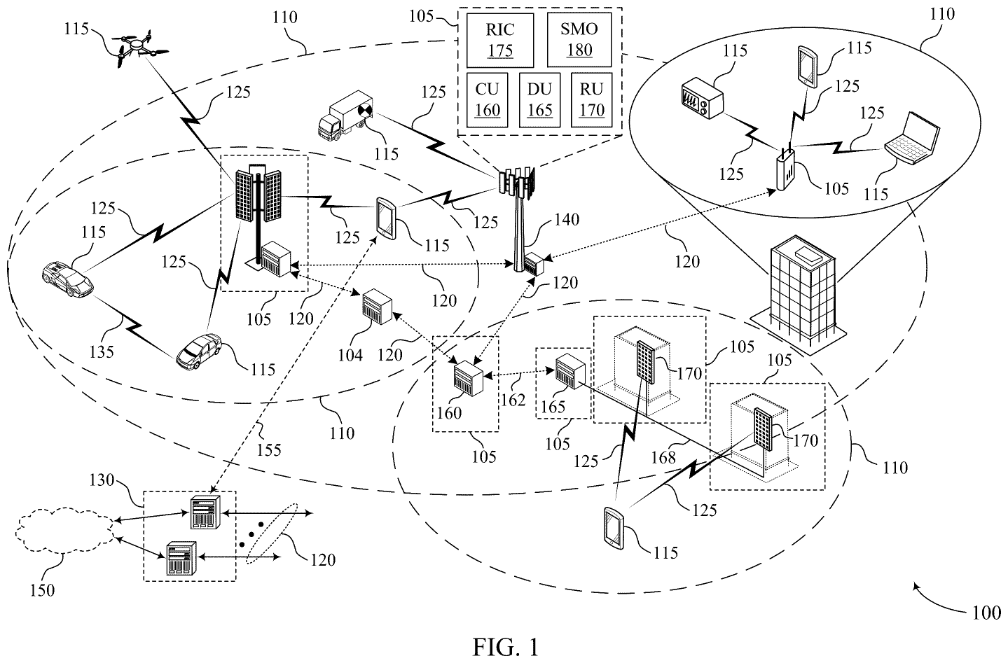

FIG. 1 shows an example of a wireless communications system 100 that supports identifying random access occasions for UE-specific random access configurations in SBFD symbols in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a network entity 105 may configure a UE 115 to only identify random access occasions within TDD symbols, to identify random access occasions within TDD symbols and SBFD symbols using the same configuration, or to identify random access within TDD symbols and SBFD symbols using separate configurations. However, a UE 115 may be unable to determine which random access occasion identification configuration the UE 115 should use. For example, based on network conditions or conditions at the UE 115, using one of the configurations may result in an increase in latency of communication based on the UE 115 not identifying all the possible random access occasions for random access preamble transmissions. In another example, using a respective random access occasion identification procedure may result in an increase in resource communication and can reduce the efficiency, reliability, and accuracy of communications within the wireless communications system 100.

To ensure reliable and efficient communications, in accordance with the techniques of the present disclosure, a UE 115 may be implicitly or explicitly indicated on how to determine valid random access occasions for random access. For example, a UE 115 may receive a control signal from a network entity 105 that indicates a random access occasion identification procedure that the UE 115 should use. In some cases, the UE 115 may also identify that each UE-random access configuration that the network entity 105 configures for the UE 115 may include a default random access occasion identification procedure. Thus, based on the default configuration or the indication within a control signal the UE 115 may be explicitly configured to identify random access occasions within in TDD symbols only, to identify random access occasions within both TDD symbols and SBFD symbols using a same configuration, or to identify random access occasions within TDD symbols using a first configuration and within SBFD symbols using a second configuration.

In some cases, a UE 115 may identify which random access occasion identification procedure to use implicitly based on identifying a type of random access procedure that the network entity 105 configures the UE 115 with. For example, based on the network entity 105 configuring the UE 115 with a CBRA procedure or a CFRA procedure, the UE 115 may identify an associated random access occasion identification procedure to use. Thus, the techniques of the present disclosure may enable UEs 115 to receive (e.g., implicitly or explicitly) an indication of a random access occasion identification procedure to use. Moreover, such indication may ensure that such random access occasion identification and random access preamble transmission refrains from impacting the efficiency, reliability, and accuracy of communications within the wireless communications system 100.

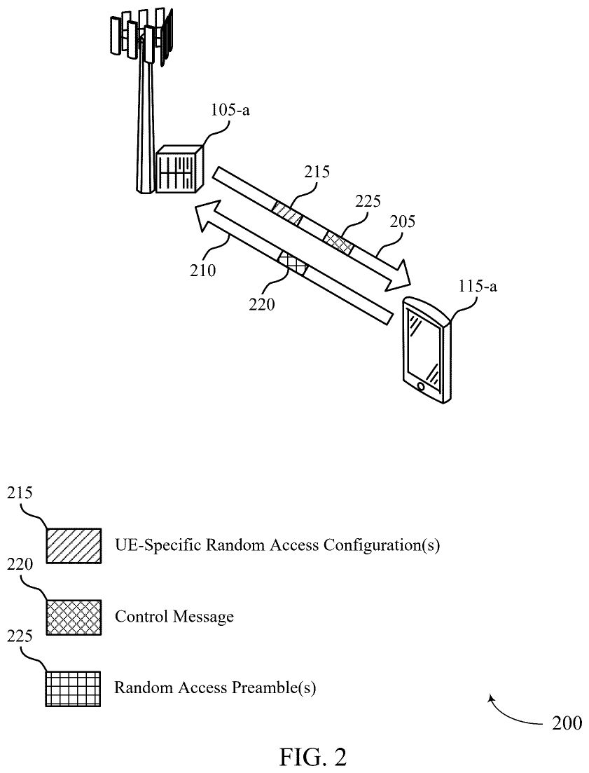

FIG. 2 shows an example of a wireless communications system 200 that supports identifying random access occasions for UE-specific random access configurations in SBFD symbols in accordance with one or more aspects of the present disclosure. In some examples, the wireless communications system 200 may implement or be implemented by the wireless communications system 100. For example, the wireless communications system 200 may include a network entity 105-a and a UE 115-a, which may be examples of devices described herein with reference to FIG. 1. In some examples, the network entity 105-a may communicate with the UE 115-a via a downlink communication link 205 and the UE 115-a may communicate with the network entity 105-a via an uplink communication link 210, which may be examples of a communication link 125 described herein with reference to FIG. 1. For example, the downlink communication link 205 and the uplink communication link 210 may be examples of a Uu link, a sidelink, a backhaul link, a D2D link, or some other type of communication link 125 described herein with reference to FIG. 1.

In some examples, the UE 115-a may receive one or more UE-specific random access configurations 215 that are associated with random access-triggering events. In some cases, the one or more UE-specific random access configurations 215 may be considered physical random access channel (PRACH) configurations that can be used for the UE 115-a to transmit one or more random access preambles 220, to request uplink resource allocations, or a combination thereof. Further, in some cases, the random access-triggering events may be contention-based, contention-free, or both. In some examples, the one or more random access-triggering events may include an initial access from a RRC idle state that is contention-based that is based on the UE 115-a transmitting an RRC setup request message (e.g., an RRCSetupRequest in message 3 (MSG3)). In some examples, a UE-specific random access configuration 215 may also be triggered by the UE 115-a transmitting an RRC resume request message (e.g., an RRCResumeRequest in MSG3) that is contention-based to transition the UE 115-a from an RRC inactive to an RRC connected state. Another UE-specific random access configuration 215 can be triggered based on the UE 115-b transmitting an RRC connection reestablishment message (e.g., an RRCReestablishmentRequest in MSG3).

In another example, the UE 115-a may be configured with a UE-specific random access configuration 215 that is triggered based on initiating a handover procedure that is either contention-based or contention-free. For example, the network entity 105-a may provide a preamble using a dedicated configuration for a random access channel (RACH) within an RRC reconfiguration message (e.g., a preamble using RACH-ConfigDedicated within RRCReconfiguration). The UE 115-a may then send an RRC reconfiguration complete message after completing the handover (e.g., an RRCReconfigurationComplete in MSG3).

In some examples, the UE 115-a may be configured with a UE-specific random access configuration 215 that is triggered based on the UE 115-a receiving downlink data while the UE 115-a is out-of-sync. In such cases, the network entity 105-a may signal a downlink control channel (e.g., a physical downlink control channel (PDCCH) order (e.g., a PDCCH-Order) in a downlink control information (DCI) using a DCI format (e.g., DCI 1_0) with a preamble index when contention-based and without a preamble index when contention-free. For a contention resolution, the UE 115-a may transmit a cell-radio network temporary identifier (C-RNTI) medium access control (MAC)-control element (CE) message (e.g., a C-RNTI MAC-CE in MSG3). The UE 115-a may also be configured with a UE-specific random access configuration that is triggered based on uplink data arrival while the UE 115-a is out-of-sync, without an uplink shared channel (e.g., a physical uplink shared channel (PUSCH)) resource allocation, or both. In such examples, for a contention resolution the UE 115-a may use a C-RNTI MAC-CE. Additionally, or alternatively, the UE 115-a may use a buffer status report (BSR) MAC-CE to request additional uplink resources from the network entity 105-a.

In some examples, the UE 115-a may be configured with a UE-specific random access configuration 215 that can be contention-based or contention-free and is triggered based on on-demand system information. In a contention-based example, the network entity 105-a may refrain from including a system information request configuration (e.g., a si-RequestConfig) in a first system information block (SIB1) and the UE 115-a may sent an RRC system information request (e.g., a rrcSystemInfoRequest in MSG3). In a contention-free example, the network entity 105-a may include the system information request configuration in the SIB1. The UE 115-a may then transmit a specific random access preamble (e.g., PRACH preamble in MSG1) to request specific information and monitor a PDCCH for system information after MSG2. Another UE-specific random access configuration 215 may be triggered based on a beam failure recovery that can be contention-based or contention-free. For a contention-based scenario, the UE may select a PRACH preamble that corresponds to a synchronization signal block (SSB) beam for recovery. In a contention-free scenario, the network entity 105-a may provide the UE 115-a with a single PRACH preamble index for each beam available for recovery.

For a UE-specific random access configuration 215 that is triggered based on a scheduling request failure, the UE-specific random access configuration 215 may bee contention-based and the UE 115-a may use random access if the network entity 105-a fails to provide an uplink grant after a threshold quantity of scheduling requests (e.g., after sr-TransMax which can be between 4 and 64). Further, a UE-specific random access configuration 215 may be triggered by a synchronous reconfiguration and may be contention-based or contention-free. In such examples, the network entity 105-a may trigger synchronous reconfiguration messages (e.g., reconfigurationWithSync within RRCReconfiguration) such that the UE 115-a can perform contention-based or contention-free random access (e.g., ra-PreambleIndex excluded from or included in reconfigurationWithSync respectively). Additionally, or alternatively, a UE-specific random access configuration 215 may be triggered based on establishing a time alignment during a secondary cell (SCell) addition that can be contention-based or contention-free. In such cases, the UE-specific random access configuration 215 may be used to initialize a timing advance of an added SCell that belongs to a timing advance group (TAG) where the UE-specific random access configuration 215 is contention-based or contention-free based on whether a preamble index is included in a configuration (e.g., whether ra-PreambleIndex is excluded form reconfigurationWithSync).

Random access-triggering events may also be based on the UE 115-a being in an RRC connected mode, uplink listen before talk (LBT) failures, uplink synchronization, UE 115 positioning, RACH-based LTM cell switches, or any combination thereof. Additionally, or alternatively, the UE 115-a may be semi-statically configured with the UE-specific random access configurations 215 for some random access-triggering events (e.g., mainly for CFRA). Further, if the network entity 105-a refrains from configuring the UE 115-a with a UE-specific random access configuration 215, the UE 115-a may utilize a common random access configuration (e.g., a common PRACH configuration).

Thus, using the various UE-specific random access configurations 215 the UE 115-a may transmit the one or more random access preambles 220 during one or more random access occasions. In some cases, as described elsewhere herein, the UE 115-a may be a UE 115 that is aware of SBFD symbols and may be capable of identifying random access occasions in uplink bands of an SBFD symbol. To support the UE 115-a that is aware of SBFD symbols, the network entity 105-a may configure the UE 115-a with indications associated with SBFD operations within a TDD carrier. For example, the network entity 105-a may semi-statically indicate a time location of SBFD subbands (e.g., uplink subbands, downlink subbands, guard band subbands, or any combination thereof) to UEs 115 in an RRC connected mode (e.g., the UE 115-a). Further, the network entity 105-a may also semi-statically indicate a frequency domain location of SBFD subbands to UEs 115 in the RRC connected mode. Such indications may provide UEs 115 (e.g., the UE 115-a) with support for performing random access procedures in SBFD symbols while in an RRC connected mode.

In some examples, for random access operations performed the UE 115-a in an RRC connected mode, the UE 115-a may use one of two options for determining valid random access occasions. In a first option, the UE 115-a may use a single RACH configuration (e.g., a single UE-specific random access configuration 215) that can be used for determining valid random access occasions within uplink subbands in SBFD symbols. In a second option, the UE 115-a may use two separate RACH configurations that includes a traditional or standard RACH configuration and an additional RACH configuration. Thus, the UE 115-a may be capable of identifying valid random access occasions within the uplink subbands in SBFD symbols in accordance with the additional RACH configuration. In some cases, using the first option may allow for a lack of any additional signaling and UEs 115 unaware of SBFD symbols may be capable of leveraging random access occasions in SBFD symbols if the random access occasions are configured in flexible (FL) SBFD symbols (e.g., SBFD-FL symbols) In some cases, after UE 115-a is configured with a TDD configuration (e.g., a TDD_UL_DL_Config) all the slots may be either uplink slots, downlink slots, or flexible slots that can be used for uplink or downlink communications. Based on the UE 115-a receiving a SBFD configuration, the SBFD slots may be used in place of downlink slots or flexible slots. Thus, in some cases, DL-SBFD, FL-SBFD, or both may refer to a slot origin type.

However, the UE 115-a may be restricted to using the same RRC configuration of a common PRACH configuration for identifying random access occasions in both TDD symbols and SBFD symbols. In some cases, using the second option may allow for flexibility when the UE 115-a identifies and selects random access occasions. For example, the separate RACH configurations may have separate parameters (e.g., preambles, random access occasion time and frequency resources, power configurations, or any combination thereof). However, having separate configurations may result in an increase in signaling overhead and the random access occasions within SBFD symbols may only be applicable to SBFD-aware UEs 115 (e.g., the UE 115-a).

Therefore, in some cases, due to limitations at the UE 115-a it may be beneficial to use a common RACH configuration to reduce the complexity of identifying random access occasions. Therefore, establishing separate RACH configurations for identifying random access occasions in TDD symbols and SBFD symbols may aid in improving the flexibility of the random access occasion identification. However, the UE 115-a may be unable to determine which configuration may be relatively most efficient and reliable for both the UE 115-a and the network entity 105-a. Moreover, the UE 115-a may be relatively inconsistent with how the UE 115-a determines valid random access occasions as some behavior of a UE 115 for the determinations may be based on the random access-triggering events described herein.

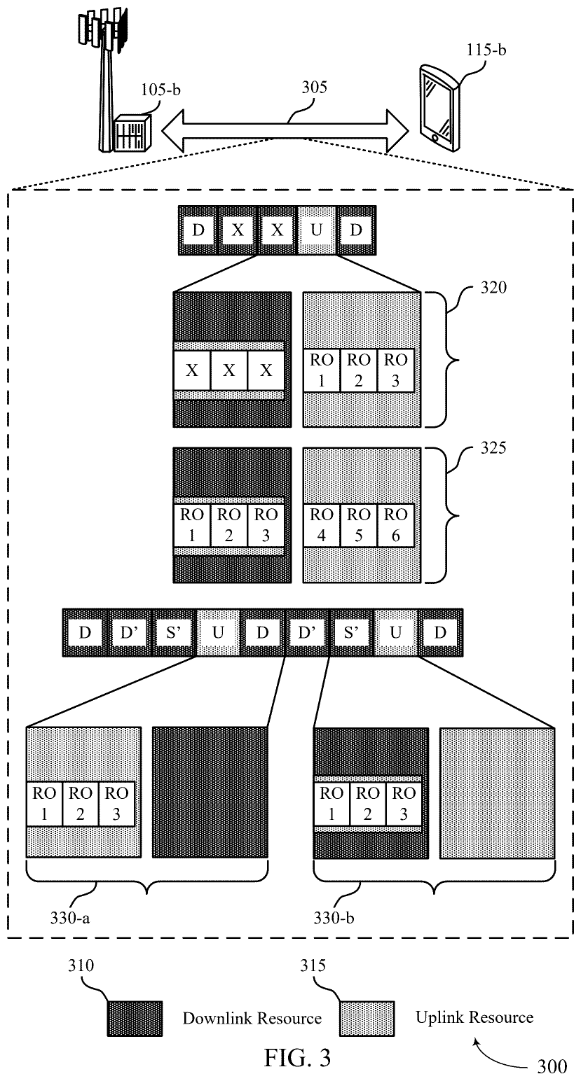

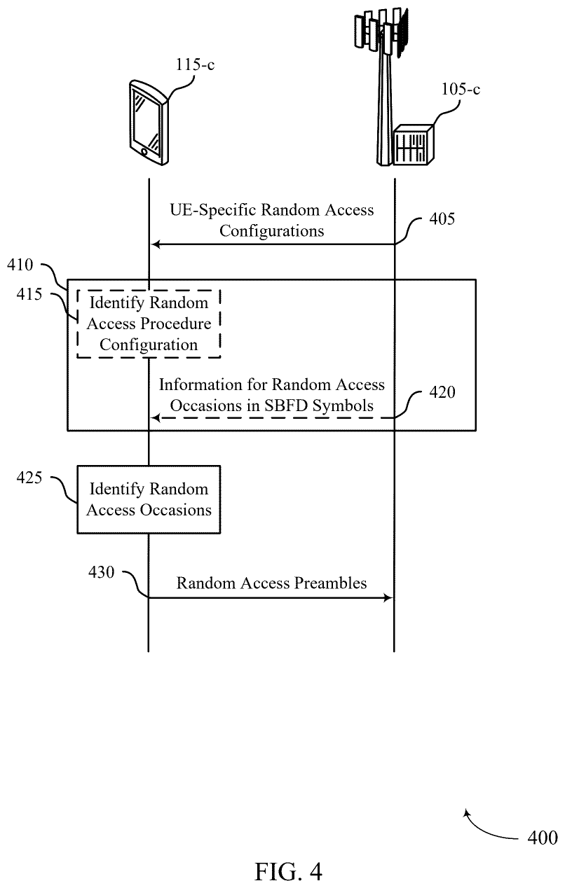

To provide the UE 115-a with a mechanism of determining valid random access occasions within TDD symbols (e.g., non-SBFD symbols) and SBFD symbols, the techniques of the present disclosure may describe the UE 115-a being enabled to obtain information that is indicative of whether the UE 115-a is configured to use random access occasions in SBFD symbols. In some examples, the UE 115-a may obtain the information based on receiving a control signal 225 from the network entity 105-a. For example, the network entity 105-a may transmit a control signal 225 to the UE 115-a indicating how the UE 115-a should identify valid random access occasions. In some cases, the network entity 105-a may indicate, via the control signal 225, that the UE 115-a should only identify any use random access occasions within TDD symbols (e.g., non-SBFD symbols) for transmission of the one or more random access preambles 220. The network entity 105-a may also indicate, via the control signal 225, that the UE 115-a should identify random access occasions within TDD symbols and SBFD symbols using the same configuration. Additionally, or alternatively, the network entity 105-a may indicate, via the control signal 225, that the UE 115-a should identify random access occasions within TDD symbols and SBFD symbols using two separate configurations. Further, in some examples, the UE 115-a may obtain the information based on identifying a random access procedure that the network entity 105-a configured the UE 115-a with and identifying a random access occasion identification procedure to use based on the configured random access procedure. Further descriptions of the techniques of the present disclosure including the different random access identification procedures that the UE 115-a can be configured with may be described elsewhere herein, such as with reference to FIGS. 3-4.

FIG. 3 shows an example of a wireless communications system 300 that supports identifying random access occasions for UE-specific random access configurations in SBFD symbols in accordance with one or more aspects of the present disclosure. In some examples, the wireless communications system 300 may implement or be implemented by the wireless communications system 100, the wireless communications system 200, or both. For example, the wireless communications system 300 may include a network entity 105-b and a UE 115-b, which may be examples of devices described herein with reference to FIG. 1. In some examples, the network entity 105-b and the UE 115-b via a communication link 305, which may be examples of a communication link 125 described herein with reference to FIG. 1. For example, the communication link 305 may be examples of an uplink communication link, a downlink communication link, a combination of an uplink and a downlink communication link, a Uu link, a sidelink, a backhaul link, a D2D link, or some other type of communication link 125 described herein with reference to FIG. 1. Further, within the illustration of FIG. 3, the resources labeled as D and D′ may represent downlink resources 310 of downlink TDD symbols, X and S′ may represent downlink resources 310 of SBFD symbols that include uplink resources 315 within an uplink subband, and U may represent uplink resources 315 of uplink TDD symbols.

In some examples, as described with reference to FIG. 2, the network entity 105-b and the UE 115-b may communicate via a communication link 305 which can represent a downlink communication link and an uplink communication link. In some cases, in accordance with the techniques of the present disclosure, the UE 115-b may be aware of SBFD symbols and the network entity 105-b may configure the UE 115-b with one or more UE-specific random access configurations. In some cases, the UE-specific random access configurations may be referred to as UE-dedicated PRACH configurations and the respective configuration may indicate PRACH resources and configurations for respective random access-triggering events (e.g., RACH triggering events described with reference to FIG. 2). Moreover, in some cases, the network entity 105-b may also indicate to the UE 115-b on how to determine valid random access occasions in downlink resources 310 and uplink resources 315 for the UE 115-b to transmit random access preambles to the network entity 105-b.

In some cases, the UE 115-b may be configured with a random access occasion identification configuration 320 where the UE 115-b may only identify random access occasions during uplink resources 315 in TDD symbols. Additionally, or alternatively, the UE 115-b may be configured with a random access occasion identification configuration 325 where the UE 115-b can identify random access occasions in both uplink resources 315 of uplink symbols and slots and within uplink resources 315 of an SBFD symbol (e.g., within an uplink subband of the downlink resources 310 of an SBFD symbol). The UE 115-b may also be configured with a set of random access occasion identification configurations 330 that includes a random access occasion identification configuration 330-a and a random access occasion identification configuration 330-b. In some examples, the UE 115-b may use the random access occasion identification configuration 330-a to identify random access occasions in uplink resources 315 of TDD symbols and the random access occasion identification configuration 330-b to identify random access occasions within uplink resources 315 (e.g., uplink resources 315 of an uplink subband) of the downlink resources 310 of SBFD symbols. For example, SBFD symbols may be allocated with downlink resources 310 and can include one or more uplink subbands that include uplink resources 315. Thus, the UE 115-b may use the random access occasion identification configuration 325 and the random access occasion identification configuration 330-b to identify random access occasions within the uplink resources 315 of uplink subbands in respective SBFD symbols.

In some examples, within the UE-specific random access configurations that the network entity 105-b configures for the UE 115-b, each respective UE-specific random access configuration may include a default configuration for identifying random access occasions. Thus, each UE-dedicated PRACH configuration may include a parameter (e.g., PRA CH-configuration-generic) indicating which configuration (e.g., the random access occasion identification configuration 320, the random access occasion identification configuration 325, or the set of random access occasion identification configurations 330) the UE 115-b should default to using. In some examples, the network entity 105-b may explicitly indicate which configuration the UE 115-b should use within a control message to the UE 115-b. In some cases, the explicit indication from the network entity 105-b may be indicated via an additional parameter of the control message. For example, the network entity 105-b may transmit an RRC message to the UE 115-b that includes an additional RRC parameter for indicating a PRACH configuration index to the UE 115-b. In some examples, the PRACH configuration index may point to an index of a table of different random access occasion identification procedures that the UE 115-b is capable of utilizing.

Additionally, or alternatively, the network entity 105-b may transmit the control message indicating for the UE 115-b to use a respective configuration for identifying random access occasions semi-statically and the control message may apply to a subset of the UE-specific random access configurations. For example, when the subset of the UE-specific random access configurations are triggered by the corresponding random access-triggering event the UE 115-b may use the indicated random access occasion identification configuration. Otherwise, for the remainder of the UE-specific random access configurations, the UE 115-b may default to using the random access occasion identification configuration 320. In some cases, an indication of such subset of UE-specific random access configurations may be included within the same control message or be indicated within a separate control message from the network entity 105-b.

Thus, when the UE 115-b is aware of SBFD symbols, in some cases, the network entity 105-b may indicate (e.g., via a PRACH configuration index in a parameter of an RRC message) for the UE 115-b to use the random access occasion identification configuration 320 to only identify valid random access occasions in non-SBFD symbols. In some cases, the network entity 105-b may indicate for the UE 115-b to use the random access occasion identification configuration 325 to identify random access occasions within both non-SBFD symbols (e.g., TDD symbols) and SBFD symbols. The network entity 105-b may also indicate for the UE 115-b to use the random access occasion identification configuration 330-a for identifying random access occasions in non-SBFD symbols and the random access occasion identification configuration 330-b for identifying random access occasions in SBFD symbols. Such indications may be indicated via the PRACH configuration index in the additional parameter of a control message from the network entity 105-b. Additionally, or alternatively, if the network entity 105-b refrains from configuring the control message with the additional parameter, in some cases, the UE 115-b may default to using the random access occasion identification configuration 320 and only identify random access occasions during the downlink resources 310 of non-SBFD symbols for random access preamble transmissions.

In some examples, the network entity 105-b may configure the UE 115-b to use the random access occasion identification configuration 325 to identify random access occasions in both TDD symbols and SBFD symbols with the same configuration. In some cases, when configured with the random access occasion identification configuration 325 the UE 115-b may only select random access occasions identified within uplink resources 315 of uplink subbands in the downlink resources 310 of SBFD symbols for random access preamble transmissions. Thus, the UE 115-b may transmit random access preambles during the uplink resources 315 of uplink subbands in the downlink resources 310 of SBFD symbols and refrain from transmitting random access preambles during the uplink resources 315 of non-SBFD symbols.

In some cases, when configured with the random access occasion identification configuration 325, the UE 115-b may select random access occasions within either the downlink resources 310 of TDD symbols or the uplink resources 315 of the uplink subbands in the downlink resources 310 of SBFD symbols for random access preamble transmissions. In such cases, the UE 115-b may determine to use the random access occasions from TDD symbols or from SBFD symbols based on the respective symbols being associated with one or more reference signals and based on a reference signal configuration from the network entity 105-b. For example, the UE 115-b may receive a reference signal configuration from the network entity 105-b that indicates a prioritization of resources associated with respective reference signals (e.g., SSBs, CSI-RSs). Thus, based on the prioritization of the indicated reference signals that are associated with respective TDD symbols and SBFD symbols, the UE 115-b may determine whether to select random access occasions that are identified in the TDD symbols or the SBFD symbols.

Additionally, or alternatively, when configured with the random access occasion identification configuration 325, the UE 115-b may only select the random access occasions identified in the SBFD symbols based on one or more thresholds being satisfied. For example, if the UE 115-b determines that an reference signal received power (RSRP) threshold, a transmission power threshold, or both are satisfied, the UE 115-b may determine to select random access occasions from an SBFD symbol to transmit one or more random access preambles. Otherwise, the UE 115-b determines that the RSRP threshold, the transmission power threshold, or both are unsatisfied, the UE 115-b may select random access occasions within the uplink resources 315 of non-SBFD symbols.

In some examples, rather than transmitting an explicit indication of a random access occasions for the UE 115-b to utilize via an RRC message, the network entity 105-b may transmit the explicit indication via a DCI message. For example, for PDCCH order triggered UE-specific random access configurations (e.g., configurations triggered via the UE 115-b receiving a message from the network entity 105-b on the PDCCH) the network entity 105-b transmit the explicit indication to the UE 115-b via a DCI-bit indication. In some cases, the DCI-bit indication may indicate for the UE 115-b to utilize the random access occasion identification configuration 325 and the UE 115-b may determine whether to select a random access occasion for a random access preamble transmission from a TDD symbol or an SBFD symbol as described elsewhere herein. Additionally, or alternatively, the DCI-bit indication may indicate for the UE 115-b to use the set of random access occasion identification configurations 330 and the UE 115-b can determine whether to select a random access occasion for a random access preamble transmission accordingly. For example, the UE 115-b may use the random access occasion identification configuration 330-a to select a random access occasion from a pool of random access occasions identified via the random access occasion identification configuration 330-a. In another example, the UE 115-b may use the random access occasion identification configuration 330-b to select a random access occasion from a pool of configured random access occasions identified via the random access occasion identification configuration 330-b. Additionally, or alternatively, the UE 115-b may receive a first control message that includes a parameter (e.g., a RRC message that includes a RRC parameter) indicating an existence of a bitfield of a payload of a second control message (e.g., a DCI bitfield of a DCI payload) to indicate which configuration the UE 115-b should utilize for identifying random access occasions. In some cases, if the UE 115-b determines that an absence of such parameter within the first control message, the UE 115-b may default to using the random access occasion identification configuration 320.

In some cases, the network entity 105-b may refrain from transmitting a control message or indication to the UE 115-b that indicates which random access occasion identification configuration the UE 115-b should utilize. In such cases, the UE 115-b may determine which random access occasion identification configuration to utilize based on a random access procedure configured at the UE 115-b. For example, the UE 115-b may be configured with either a first random access procedure that is associated with CBRA or a second random access procedure that is associated with CFRA. In some cases, based on determining which random access procedure the UE 115-b is configured with, the UE 115-b may determine or assume which random access occasion identification configuration should be utilized. For example, CBRA in SBFD slots may be more efficient, accurate, reliable, or any combination thereof compared to other slots (e.g., slots within non-SBFD symbols). Thus, if the network entity 105-b configures the UE 115-b with CFRA, the UE 115-b may assume that the random access occasion identification configuration 320 should be utilized (e.g., random access occasions should only be identified in non-SBFD TDD symbols). Additionally, or alternatively, if the network entity 105-b configures the UE 115-b with CBRA, the UE 115-b should assume that the random access occasion identification configuration 325 should be utilized (e.g., random access occasions can be identified in non-SBFD TDD symbols and TDD symbols). Therefore, the UE 115-b may obtain the information of whether the UE 115-b is configured to use the SBDF symbols for random access occasion identification based on a type of random access procedure configured at the UE 115-b. Further, it should be understood that the UE 115-b may determine to utilize the random access occasion identification configuration 320, the random access occasion identification configuration 325, or the set of random access occasion identification configurations 330 for any type of random access procedure that is configured at the UE 115-b.

Therefore, in accordance with the techniques of the present disclosure, the UE 115-b may be capable of improving the efficiency, reliability, accuracy, or any combination thereof, of communications with the network entity 105-b based on either implicitly or explicitly obtaining information indicative of which random access occasion identification configuration the UE 115-b should utilize. For example, by explicitly receiving an indication via a control message from the network entity 105-b, the UE 115-b may be capable of determining how to identify and select random access occasions without wasting resources or power at the UE 115-b. Thus, if the UE 115-b determines the random access occasion identification configuration based on identifying a type of random access procedure configured at the UE 115-b, the UE 115-b may be capable of identifying a configuration without any increase in signaling overhead. Further descriptions of the techniques of the present disclosure may be described elsewhere herein, such as with reference to FIG. 4.

FIG. 4 shows an example of a process flow 400 that supports identifying random access occasions for UE-specific random access configurations in SBFD symbols in accordance with one or more aspects of the present disclosure. In some examples, the process flow 400 may implement or be implemented by the wireless communications system 100, the wireless communications system 200, the wireless communications system 300, or any combination thereof. For example, the process flow 400 may include a UE 115-c and a network entity 105-c, which may be examples of devices described herein with reference to FIGS. 1 through 3.

In the following description of the process flow 400, the operations between the UE 115-c and the network entity 105-c may be performed in different orders or at different times. Some operations may also be left out of the process flow 400, or other operations may be added. Although the UE 115-c and the network entity 105-c are shown performing the operations of the process flow 400, some aspects of some operations may also be performed by one or more other wireless devices.

At 405, the UE 115-c may receive, from the network entity 105-c, one or more UE-specific random access configurations each associated with respective random access-triggering events. Moreover, each respective UE-specific random access configuration may be associated with a respective random access-triggering event. Further, the one or more UE-specific random access configurations may be indicative of a set of random access occasions for random access (e.g., for transmission of random access preambles).

At 410, the UE 115-c may obtain information that is indicative of whether the UE 115-c is configured to use random access occasions in SBFD symbols. In some examples, the UE 115-c may obtain an indication to use a random access occasion identification configuration from a set of random access occasion identification configurations. For example, the set of random access occasion identification configurations may include a first random access occasion identification configuration for identifying only the random access occasions of the set of random access occasions associated with TDD symbols (e.g., non-SBFD symbols), a second random access occasion identification configuration for identifying the random access occasions of the set of random access occasions of TDD symbols and one or more random access occasions of SBFD symbols, and a third random access occasion identification configuration that includes one configuration for identifying only the random access occasions of TDD symbols and another configuration for identifying only the random access occasions of SBFD symbols.

Further, the one or more UE-specific random access configurations that are associated with the respective random access-triggering events may include indications of a default random access occasion identification configuration from the set of random access occasion identification configurations that the UE 115-c should utilize. Moreover, in some cases, the UE 115-c may identify that the obtained information of whether the UE 115-c is configured to use the random access occasions in SBFD symbols may be associated with a subset of UE-specific random access configurations of the one or more UE-specific random access configurations. Additionally, or alternatively, the UE 115-c may obtain, via the information, an indication that the UE 115-c is configured to use the random access occasions in the SBFD symbols.

At 415, in some examples, the UE 115-c may obtain the information that is indicative of whether the UE is to use the random access occasions (e.g., configured to use) in the SBFD symbols based on identifying that the UE 115-c is configured with a respective random access procedure. For example, the UE 115-c may identify whether the UE 115-c is configured with a first random access procedure or a second random access procedure. In some cases, the first random access procedure may be a CBRA and the second random access procedure may be a CFRA.

At 420, in some examples, the UE 115-c may obtain the information that is indicative of whether the UE is to use (e.g., configured to use) the random access occasions in the SBFD symbols based on a control signal. For example, the UE 115-c may receive, via a control signal, the information that is indicative of whether the UE 115-c is configured to use the random access occasions in the SBFD symbols. In some cases, the control signal may include a parameter whose value is a configuration index that indicates the information. Further, the control message may indicate that the UE 115-c is not configured (e.g., unable) to use the random access occasions in the SBFD symbols based on an absence, in the control message, of a parameter whose value is a configuration index that, when present, indicates the information. Moreover, the control signal may be a RRC message. In some examples, the UE 115-c may obtain the information that is indicative of whether the UE 115-c is configured to use the random access occasions in the SBFD symbols via a bit of a control signal from the network entity 105-c. In such examples, the control message may be a DCI message.

At 425, the UE 115-c may identify that one or more random access occasions of the set of random access occasions are within a SBFD symbol. In some cases, based on identifying the one or more random access occasions within a SBFD symbol, the UE 115-c may select a random access occasion for transmitting one or more random access preambles where the random access occasion is selected from a pool of respective random access occasions that are available for transmission of the one or more random access preambles. At 430, the UE 115-c may transmit, to the network entity 105-c one or more random access preambles during the one or more random access occasions of the SBFD symbol or during other random access occasions of the set of random access occasions (e.g., random access occasions in non-SBFD symbols) based on obtaining the information at 410. In some examples, when the UE 115-c is configured to use the random access occasions in the SBFD symbols, the UE 115-c may refrain from transmitting the one or more random access preambles during the other random access occasions of the set of random access occasions based on being configured to use the random access occasions in the SBFD symbols. Thus, the UE 115-c may only transmit the one or more random access preambles during the one or more random access occasions of SBFD symbols. In another example, the UE 115-c may receive a second control signal that indicates a reference signal prioritization, and the UE 115-c may transmit the one or more random access preambles during the non-SBFD symbols or the SBFD symbols based on the reference signal prioritization. In some examples, the UE 115-c may only transmit the one or more random access preambles during the one or more random access occasions of SBFD symbols based on the UE 115-c satisfying one or more thresholds. In some cases, the one or more thresholds may include an RSRP threshold, a transmission power threshold, or a combination thereof.

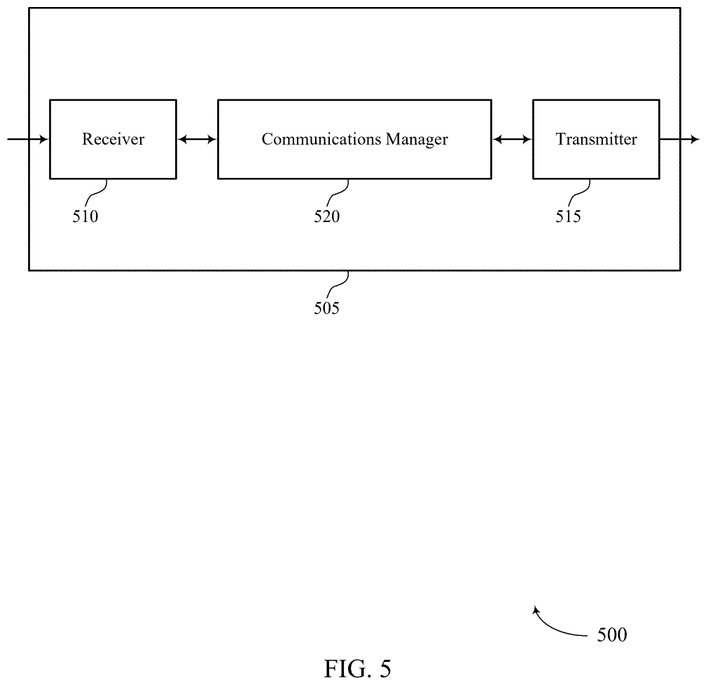

FIG. 5 shows a block diagram 500 of a device 505 that supports identifying random access occasions for UE-specific random access configurations in SBFD symbols in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to identifying random access occasions for UE-specific random access configurations in SBFD symbols). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to identifying random access occasions for UE-specific random access configurations in SBFD symbols). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of identifying random access occasions for UE-specific random access configurations in SBFD symbols as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving one or more UE-specific random access configurations each associated with respective random access-triggering events, the one or more UE-specific random access configurations each indicative of a set of multiple random access occasions for random access. The communications manager 520 is capable of, configured to, or operable to support a means for obtaining information that is indicative of whether the UE is to use random access occasions in SBFD symbols. The communications manager 520 is capable of, configured to, or operable to support a means for identifying that one or more random access occasions of the set of multiple random access occasions are within a SBFD symbol. The communications manager 520 is capable of, configured to, or operable to support a means for transmitting one or more random access preambles during the one or more random access occasions of the SBFD symbol or during other random access occasions of the set of multiple random access occasions based on the information.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for a UE 115 to obtain information indicative of whether to use random access occasions in TDD symbols, SBFD symbols, or both, to support reduced processing, reduced power consumption, and more efficient utilization of communication resources.

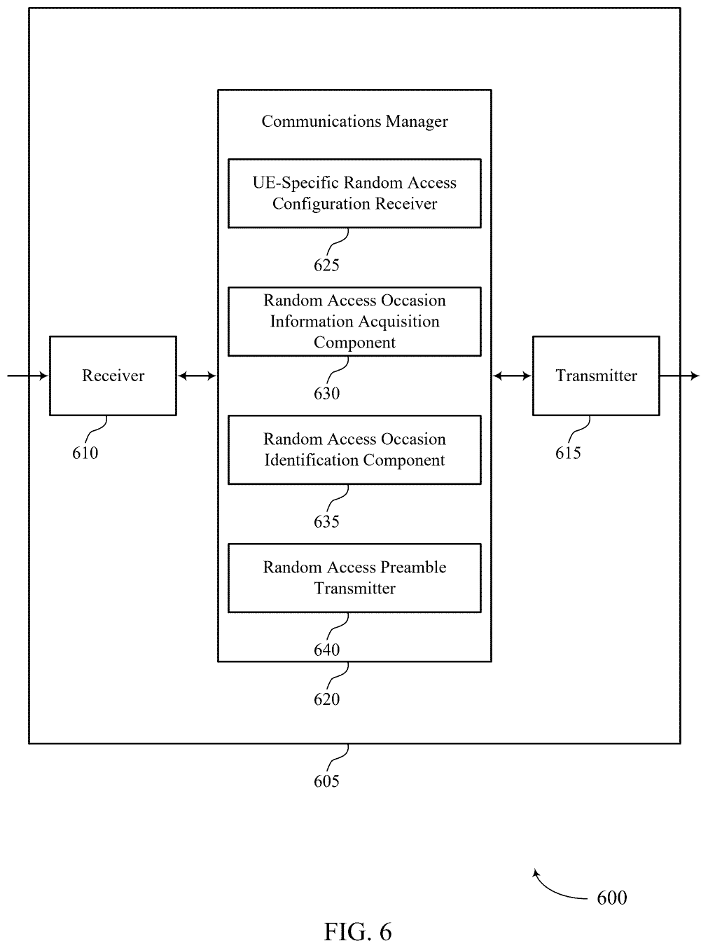

FIG. 6 shows a block diagram 600 of a device 605 that supports identifying random access occasions for UE-specific random access configurations in SBFD symbols in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to identifying random access occasions for UE-specific random access configurations in SBFD symbols). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to identifying random access occasions for UE-specific random access configurations in SBFD symbols). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of identifying random access occasions for UE-specific random access configurations in SBFD symbols as described herein. For example, the communications manager 620 may include a UE-specific random access configuration receiver 625, a random access occasion information acquisition component 630, a random access occasion identification component 635, a random access preamble transmitter 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The UE-specific random access configuration receiver 625 is capable of, configured to, or operable to support a means for receiving one or more UE-specific random access configurations each associated with respective random access-triggering events, the one or more UE-specific random access configurations each indicative of a set of multiple random access occasions for random access. The random access occasion information acquisition component 630 is capable of, configured to, or operable to support a means for obtaining information that is indicative of whether the UE is to use random access occasions in SBFD symbols. The random access occasion identification component 635 is capable of, configured to, or operable to support a means for identifying that one or more random access occasions of the set of multiple random access occasions are within a SBFD symbol. The random access preamble transmitter 640 is capable of, configured to, or operable to support a means for transmitting one or more random access preambles during the one or more random access occasions of the SBFD symbol or during other random access occasions of the set of multiple random access occasions based on the information.

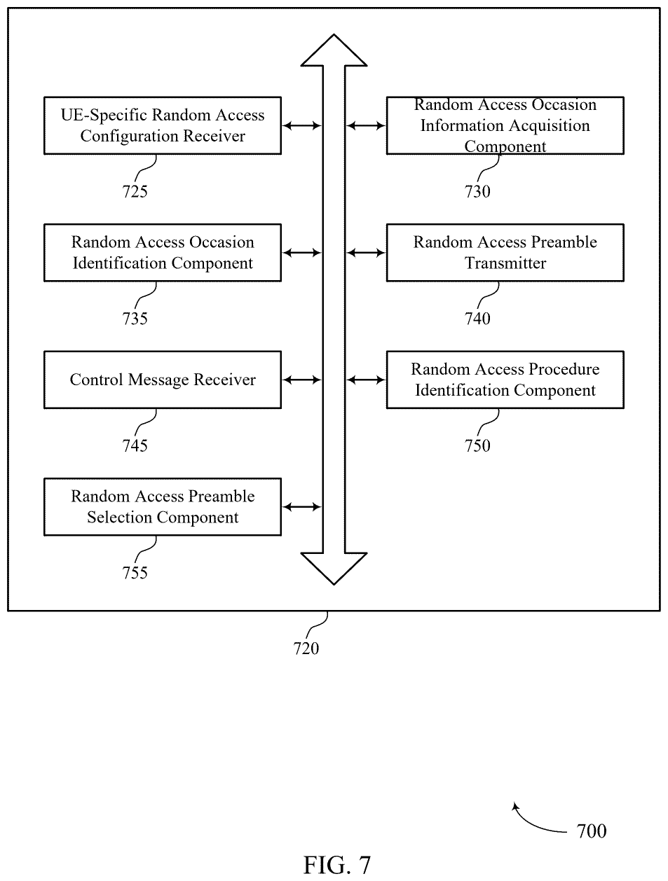

FIG. 7 shows a block diagram 700 of a communications manager 720 that supports identifying random access occasions for UE-specific random access configurations in SBFD symbols in accordance with one or more aspects of the present disclosure. The communications manager 720 may be an example of aspects of a communications manager 520, a communications manager 620, or both, as described herein. The communications manager 720, or various components thereof, may be an example of means for performing various aspects of identifying random access occasions for UE-specific random access configurations in SBFD symbols as described herein. For example, the communications manager 720 may include a UE-specific random access configuration receiver 725, a random access occasion information acquisition component 730, a random access occasion identification component 735, a random access preamble transmitter 740, a control message receiver 745, a random access procedure identification component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The UE-specific random access configuration receiver 725 is capable of, configured to, or operable to support a means for receiving one or more UE-specific random access configurations each associated with respective random access-triggering events, the one or more UE-specific random access configurations each indicative of a set of multiple random access occasions for random access. The random access occasion information acquisition component 730 is capable of, configured to, or operable to support a means for obtaining information that is indicative of whether the UE is to use random access occasions in SBFD symbols. The random access occasion identification component 735 is capable of, configured to, or operable to support a means for identifying that one or more random access occasions of the set of multiple random access occasions are within a SBFD symbol. The random access preamble transmitter 740 is capable of, configured to, or operable to support a means for transmitting one or more random access preambles during the one or more random access occasions of the SBFD symbol or during other random access occasions of the set of multiple random access occasions based on the information.

In some examples, the control message receiver 745 is capable of, configured to, or operable to support a means for receiving, via a control message, the information that is indicative of whether the UE is to use the random access occasions in the SBFD symbols, where obtaining the information is based on receiving the control message.

In some examples, the control message includes a parameter whose value is a configuration index that indicates the information.

In some examples, the control message indicates that the UE is not configured to use the random access occasions in the SBFD symbols based on an absence, in the control message, of a parameter whose value is a configuration index that, when present, indicates the information.

In some examples, the control message is a RRC message.

In some examples, to support obtaining the information, the random access occasion information acquisition component 730 is capable of, configured to, or operable to support a means for obtaining an indication to use a random access occasion identification configuration from a set of multiple random access occasion identification configurations, the set of multiple random access occasion identification configurations including a first random access occasion identification configuration for identifying only the other random access occasions of the set of multiple random access occasions, a second random access occasion identification configuration for identifying the other random access occasions of the set of multiple random access occasions and the one or more random access occasions of the SBFD symbol, and a third random access occasion identification configuration for identifying only the one or more random access occasions of the SBFD symbol.

In some examples, the one or more UE-specific random access configurations associated with the respective random access-triggering events include an indication of a default random access occasion identification configuration from the set of multiple random access occasion identification configurations.

In some examples, to support obtaining the information, the random access occasion information acquisition component 730 is capable of, configured to, or operable to support a means for obtaining, via the information, an indication that the UE is to use the random access occasions in the SBFD symbols.

In some examples, the random access preamble transmitter 740 is capable of, configured to, or operable to support a means for refraining from transmitting the one or more random access preambles during the other random access occasions of the set of multiple random access occasions based on obtaining the indication via the information, where the one or more random access preambles are transmitted only during the one or more random access occasions of the SBFD symbol based on obtaining the indication via the information.

In some examples, the control message receiver 745 is capable of, configured to, or operable to support a means for receiving a control message that indicates a reference signal prioritization, where the one or more random access preambles are transmitted during the one or more random access occasions of the SBFD symbol or during the other random access occasions of the set of multiple random access occasions based on the reference signal prioritization and on obtaining the indication via the information.

In some examples, the random access preamble transmitter 740 is capable of, configured to, or operable to support a means for selecting, based on the UE satisfying one or more thresholds, the one or more random access occasions of the SBDFD symbol and transmitting the one or more random access preambles only during the one or more random access occasions of the SBFD symbol based on the UE selecting the one or more random access occasions and on obtaining the indication via the information.

In some examples, the one or more thresholds include a reference signal received power threshold, a transmission power threshold, or a combination thereof.

In some examples, to support obtaining the information, the random access occasion information acquisition component 730 is capable of, configured to, or operable to support a means for identifying that the information of whether the UE is to use the random access occasions in the SBFD symbols is associated with a subset of UE-specific random access configurations of the one or more UE-specific random access configurations.

In some examples, the control message receiver 745 is capable of, configured to, or operable to support a means for receiving, via a bit of a control message, the information that is indicative of whether the UE is to use the random access occasions in the SBFD symbols, the bit of the control message including an indication of the information, where obtaining the information is based on receiving the control message, and where the control message is triggered via a control channel order.

In some examples, the random access preamble selection component 755 is capable of, configured to, or operable to support a means for selecting a random access occasion for transmitting the one or more random access preambles, where the random access occasion is selected from a pool of respective random access occasions that are available for transmission of the one or more random access preambles.

In some examples, the control message is a DCI message, and RRC message, or a combination thereof.

In some examples, the random access procedure identification component 750 is capable of, configured to, or operable to support a means for identifying whether the UE is configured with a first random access procedure or a second random access procedure, where the information that is indicative of whether the UE is to use the random access occasions in the SBFD symbols is obtained based on identifying that the UE is configured with a respective random access procedure.

In some examples, the first random access procedure is a contention based random access procedure and the second random access procedure is a contention free random access procedure.

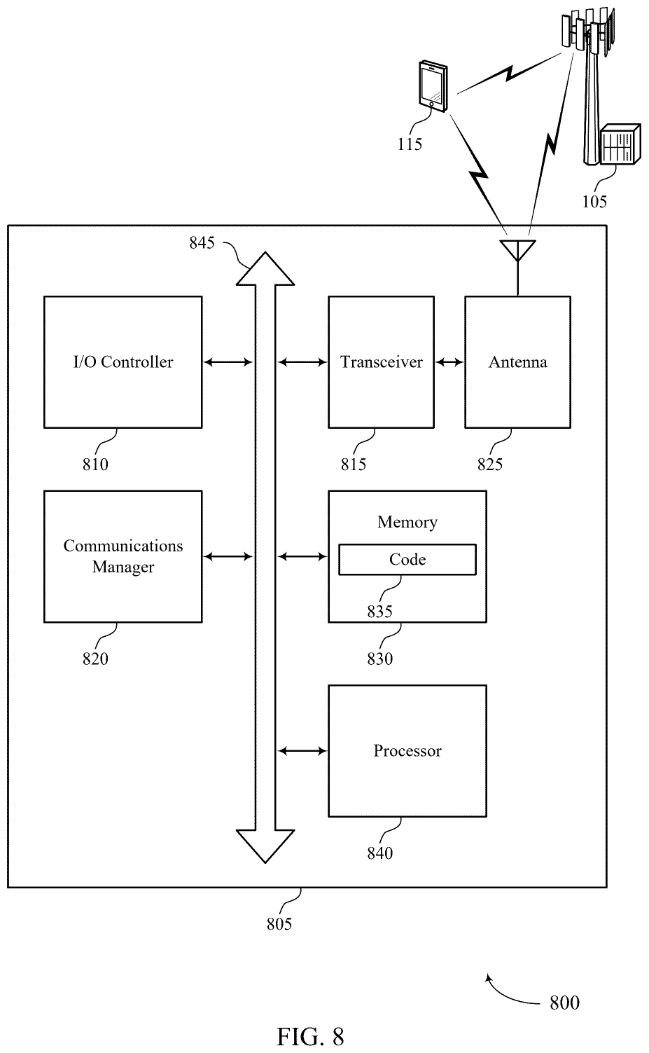

FIG. 8 shows a diagram of a system 800 including a device 805 that supports identifying random access occasions for UE-specific random access configurations in SBFD symbols in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting identifying random access occasions for UE-specific random access configurations in SBFD symbols). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving one or more UE-specific random access configurations each associated with respective random access-triggering events, the one or more UE-specific random access configurations each indicative of a set of multiple random access occasions for random access. The communications manager 820 is capable of, configured to, or operable to support a means for obtaining information that is indicative of whether the UE is to use random access occasions in SBFD symbols. The communications manager 820 is capable of, configured to, or operable to support a means for identifying that one or more random access occasions of the set of multiple random access occasions are within a SBFD symbol. The communications manager 820 is capable of, configured to, or operable to support a means for transmitting one or more random access preambles during the one or more random access occasions of the SBFD symbol or during other random access occasions of the set of multiple random access occasions based on the information.

By including or configuring the communications manager 820 in accordance with examples as described herein, the device 805 may support techniques for a UE 115 to obtain information indicative of whether to use random access occasions in TDD symbols, SBFD symbols, or both, to support improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of identifying random access occasions for UE-specific random access configurations in SBFD symbols as described herein, or the at least one processor 840 and the at least one memory 830 may be otherwise configured to, individually or collectively, perform or support such operations.

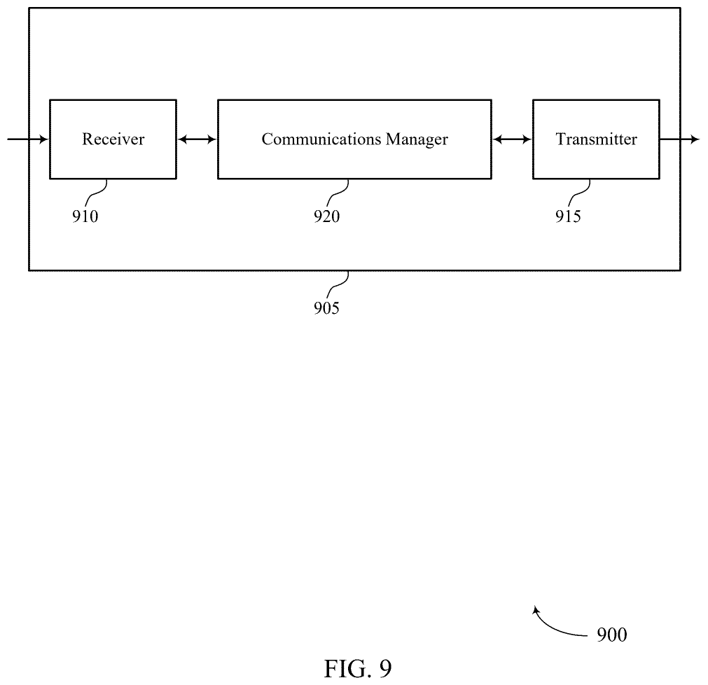

FIG. 9 shows a block diagram 900 of a device 905 that supports identifying random access occasions for UE-specific random access configurations in SBFD symbols in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of identifying random access occasions for UE-specific random access configurations in SBFD symbols as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, one or more UE-specific random access configurations each associated with respective random access-triggering events, the one or more UE-specific random access configurations each indicative of a set of multiple random access occasions for random access. The communications manager 920 is capable of, configured to, or operable to support a means for transmitting, to the UE, information that is indicative of whether the UE is to use random access occasions in SBFD symbols. The communications manager 920 is capable of, configured to, or operable to support a means for receiving, from the UE, one or more random access preambles during one or more random access occasions of a SBFD symbol or during other random access occasions of the set of multiple random access occasions based on whether the UE is to use the random access occasions in the SBFD symbols.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for a UE 115 to obtain information indicative of whether to use random access occasions in TDD symbols, SBFD symbols, or both, to support reduced processing, reduced power consumption, and more efficient utilization of communication resources.

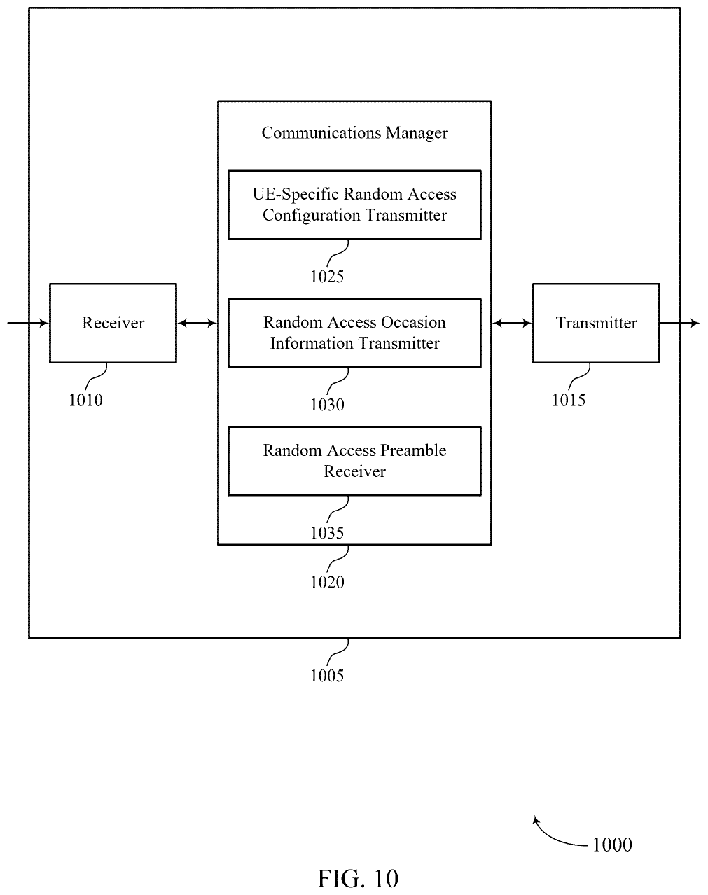

FIG. 10 shows a block diagram 1000 of a device 1005 that supports identifying random access occasions for UE-specific random access configurations in SBFD symbols in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of identifying random access occasions for UE-specific random access configurations in SBFD symbols as described herein. For example, the communications manager 1020 may include a UE-specific random access configuration transmitter 1025, a random access occasion information transmitter 1030, a random access preamble receiver 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The UE-specific random access configuration transmitter 1025 is capable of, configured to, or operable to support a means for transmitting, to a UE, one or more UE-specific random access configurations each associated with respective random access-triggering events, the one or more UE-specific random access configurations each indicative of a set of multiple random access occasions for random access. The random access occasion information transmitter 1030 is capable of, configured to, or operable to support a means for transmitting, to the UE, information that is indicative of whether the UE is to use random access occasions in SBFD symbols. The random access preamble receiver 1035 is capable of, configured to, or operable to support a means for receiving, from the UE, one or more random access preambles during one or more random access occasions of a SBFD symbol or during other random access occasions of the set of multiple random access occasions based on whether the UE is to use the random access occasions in the SBFD symbols.

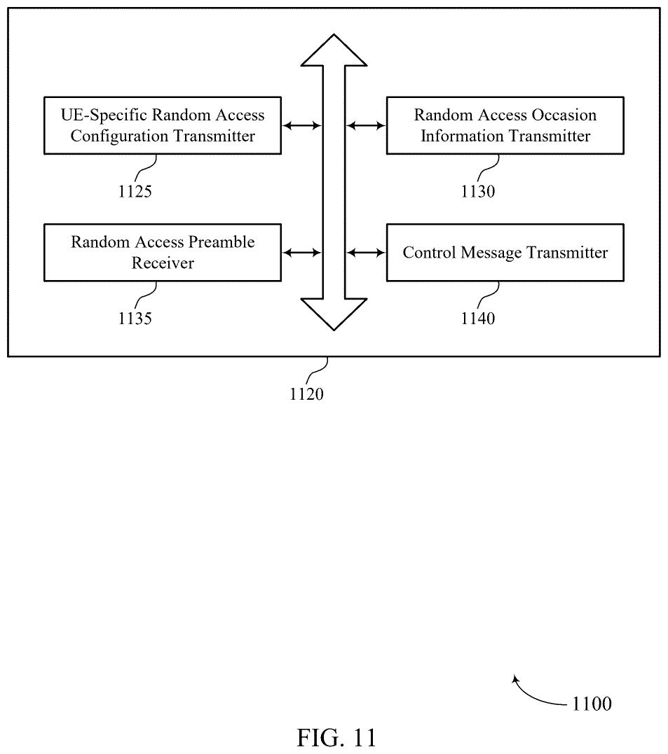

FIG. 11 shows a block diagram 1100 of a communications manager 1120 that supports identifying random access occasions for UE-specific random access configurations in SBFD symbols in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of identifying random access occasions for UE-specific random access configurations in SBFD symbols as described herein. For example, the communications manager 1120 may include a UE-specific random access configuration transmitter 1125, a random access occasion information transmitter 1130, a random access preamble receiver 1135, a control message transmitter 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The UE-specific random access configuration transmitter 1125 is capable of, configured to, or operable to support a means for transmitting, to a UE, one or more UE-specific random access configurations each associated with respective random access-triggering events, the one or more UE-specific random access configurations each indicative of a set of multiple random access occasions for random access. The random access occasion information transmitter 1130 is capable of, configured to, or operable to support a means for transmitting, to the UE, information that is indicative of whether the UE is to use random access occasions in SBFD symbols. The random access preamble receiver 1135 is capable of, configured to, or operable to support a means for receiving, from the UE, one or more random access preambles during one or more random access occasions of a SBFD symbol or during other random access occasions of the set of multiple random access occasions based on whether the UE is to use the random access occasions in the SBFD symbols.

In some examples, the control message transmitter 1140 is capable of, configured to, or operable to support a means for transmitting, to the UE via a control message, the information that is indicative of whether the UE is to use the random access occasions in the SBFD symbols, where the one or more random access preambles are received during the one or more random access occasions of the SBFD symbol based on transmitting the control message.

In some examples, the control message includes a parameter whose value is a configuration index that indicates the information.

In some examples, the control message indicates that the UE is not configured to use the random access occasions in the SBFD symbols based on an absence, in the control message, of a parameter whose value is a configuration index that, when present, indicates the information.

In some examples, the control message is a RRC message.

In some examples, to support transmitting the information, the random access occasion information transmitter 1130 is capable of, configured to, or operable to support a means for transmitting, to the UE, an indication to use a random access occasion identification configuration from a set of multiple random access occasion identification configurations, the set of multiple random access occasion identification configurations including a first random access occasion identification configuration for identifying only the other random access occasions of the set of multiple random access occasions, a second random access occasion identification configuration for identifying the other random access occasions of the set of multiple random access occasions and the one or more random access occasions of the SBFD symbol, and a third random access occasion identification configuration for identifying only the one or more random access occasions of the SBFD symbol.

In some examples, the one or more UE-specific random access configurations associated with the respective random access-triggering events include an indication of a default random access occasion identification configuration from the set of multiple random access occasion identification configurations.

In some examples, to support transmitting the information, the random access occasion information transmitter 1130 is capable of, configured to, or operable to support a means for transmitting, to the UE, an indication configuring the UE to use the random access occasions in the SBFD symbols.

In some examples, the random access preamble receiver 1135 is capable of, configured to, or operable to support a means for receiving, from the UE, the one or more random access preambles only during the one or more random access occasions of the SBFD symbol based on transmitting the indication via the information.

In some examples, the control message transmitter 1140 is capable of, configured to, or operable to support a means for transmitting, to the UE, a control message that indicates a reference signal prioritization, where the one or more random access preambles are received during the one or more random access occasions of the SBFD symbol or during the other random access occasions of the set of multiple random access occasions based on transmitting the reference signal prioritization and on transmitting the indication via the information.

In some examples, the random access preamble receiver 1135 is capable of, configured to, or operable to support a means for receiving, from the UE, the one or more random access preambles only during the one or more random access occasions of the SBFD symbol based on the UE satisfying one or more thresholds and on transmitting the indication via the information.

In some examples, the one or more thresholds include a reference signal received power threshold, a transmission power threshold, or a combination thereof.

In some examples, to support transmitting the information, the random access occasion information transmitter 1130 is capable of, configured to, or operable to support a means for transmitting, to the UE, an indication that the information of whether the UE is to use the random access occasions in the SBFD symbols is associated with a subset of UE-specific random access configurations of the one or more UE-specific random access configurations.

In some examples, the control message transmitter 1140 is capable of, configured to, or operable to support a means for transmitting, to the UE via a bit of a control message, the information that is indicative of whether the UE is to use the random access occasions in the SBFD symbols, the bit of the control message including an indication of the information, where transmitting the information is based on transmitting the control message, and where the control message is triggered via a control channel order.

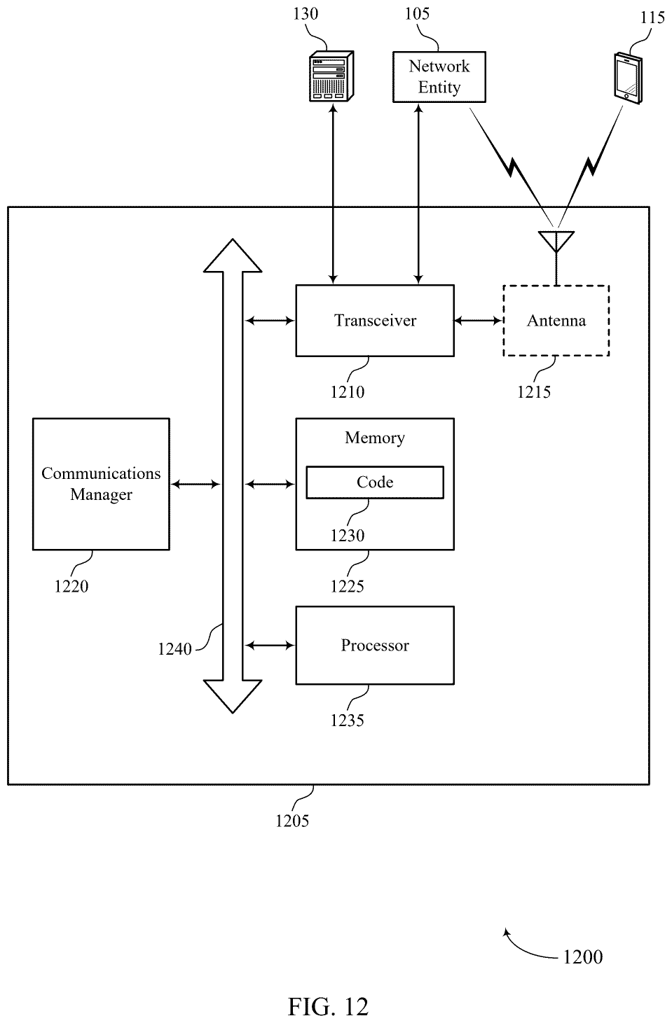

FIG. 12 shows a diagram of a system 1200 including a device 1205 that supports identifying random access occasions for UE-specific random access configurations in SBFD symbols in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting identifying random access occasions for UE-specific random access configurations in SBFD symbols). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, one or more UE-specific random access configurations each associated with respective random access-triggering events, the one or more UE-specific random access configurations each indicative of a set of multiple random access occasions for random access. The communications manager 1220 is capable of, configured to, or operable to support a means for transmitting, to the UE, information that is indicative of whether the UE is to use random access occasions in SBFD symbols. The communications manager 1220 is capable of, configured to, or operable to support a means for receiving, from the UE, one or more random access preambles during one or more random access occasions of a SBFD symbol or during other random access occasions of the set of multiple random access occasions based on whether the UE is to use the random access occasions in the SBFD symbols.

By including or configuring the communications manager 1220 in accordance with examples as described herein, the device 1205 may support techniques for a UE 115 to obtain information indicative of whether to use random access occasions in TDD symbols, SBFD symbols, or both, to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of identifying random access occasions for UE-specific random access configurations in SBFD symbols as described herein, or the at least one processor 1235 and the at least one memory 1225 may be otherwise configured to, individually or collectively, perform or support such operations.

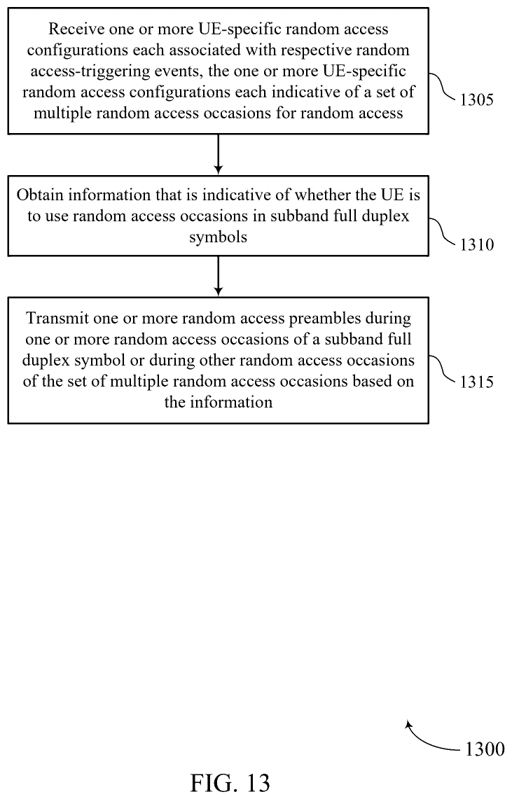

FIG. 13 shows a flowchart illustrating a method 1300 that supports identifying random access occasions for UE-specific random access configurations in SBFD symbols in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving one or more UE-specific random access configurations each associated with respective random access-triggering events, the one or more UE-specific random access configurations each indicative of a set of multiple random access occasions for random access. The operations of 1305 may be performed in accordance with examples as disclosed herein. In some examples, aspects of the operations of 1305 may be performed by a UE-specific random access configuration receiver 725 as described with reference to FIG. 7.

At 1310, the method may include obtaining information that is indicative of whether the UE is to use random access occasions in SBFD symbols. The operations of 1310 may be performed in accordance with examples as disclosed herein. In some examples, aspects of the operations of 1310 may be performed by a random access occasion information acquisition component 730 as described with reference to FIG. 7.

At 1315, the method may include transmitting one or more random access preambles during one or more random access occasions of a SBFD symbol or during other random access occasions of the set of multiple random access occasions based on the information. The operations of 1315 may be performed in accordance with examples as disclosed herein. In some examples, aspects of the operations of 1315 may be performed by a random access preamble transmitter 740 as described with reference to FIG. 7.

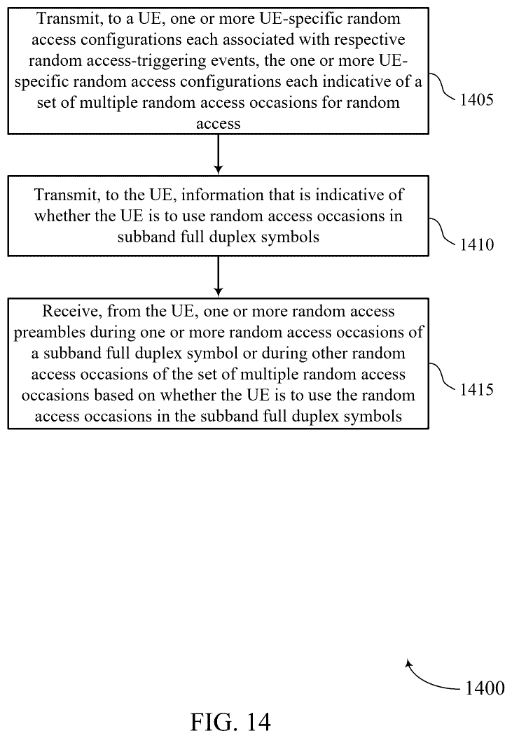

FIG. 14 shows a flowchart illustrating a method 1400 that supports identifying random access occasions for UE-specific random access configurations in SBFD symbols in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, one or more UE-specific random access configurations each associated with respective random access-triggering events, the one or more UE-specific random access configurations each indicative of a set of multiple random access occasions for random access. The operations of 1405 may be performed in accordance with examples as disclosed herein. In some examples, aspects of the operations of 1405 may be performed by a UE-specific random access configuration transmitter 1125 as described with reference to FIG. 11.

At 1410, the method may include transmitting, to the UE, information that is indicative of whether the UE is to use random access occasions in SBFD symbols. The operations of 1410 may be performed in accordance with examples as disclosed herein. In some examples, aspects of the operations of 1410 may be performed by a random access occasion information transmitter 1130 as described with reference to FIG. 11.

At 1415, the method may include receiving, from the UE, one or more random access preambles during one or more random access occasions of a SBFD symbol or during other random access occasions of the set of multiple random access occasions based on whether the UE is to use the random access occasions in the SBFD symbols. The operations of 1415 may be performed in accordance with examples as disclosed herein. In some examples, aspects of the operations of 1415 may be performed by a random access preamble receiver 1135 as described with reference to FIG. 11.

The following provides an overview of aspects of the present disclosure:

Aspect 1: A method for wireless communications by a UE, comprising: receiving one or more UE-specific random access configurations each associated with respective random access-triggering events, the one or more UE-specific random access configurations each indicative of a plurality of random access occasions for random access; obtaining information that is indicative of whether the UE is to use random access occasions in SBFD symbols; and transmitting one or more random access preambles during one or more random access occasions of a SBFD symbol or during other random access occasions of the plurality of random access occasions based at least in part on the information.

Aspect 2: The method of aspect 1, further comprising: receiving, via a control message, the information that is indicative of whether the UE is to use the random access occasions in the SBFD symbols, wherein obtaining the information is based at least in part on receiving the control message.

Aspect 3: The method of aspect 2, wherein the control message includes a parameter whose value is a configuration index that indicates the information.

Aspect 4: The method of any of aspects 2 through 3, wherein the control message indicates that the UE is not configured to use the random access occasions in the SBFD symbols based at least in part on an absence, in the control message, of a parameter whose value is a configuration index that, when present, indicates the information.

Aspect 5: The method of any of aspects 2 through 4, wherein the control message is an RRC message.

Aspect 6: The method of any of aspects 1 through 5, wherein obtaining the information comprises: obtaining an indication to use a random access occasion identification configuration from a plurality of random access occasion identification configurations, the plurality of random access occasion identification configurations comprising a first random access occasion identification configuration for identifying only the other random access occasions of the plurality of random access occasions, a second random access occasion identification configuration for identifying the other random access occasions of the plurality of random access occasions and the one or more random access occasions of the SBFD symbol, and a third random access occasion identification configuration for identifying only the one or more random access occasions of the SBFD symbol.

Aspect 7: The method of aspect 6, wherein the one or more UE-specific random access configurations associated with the respective random access-triggering events comprise an indication of a default random access occasion identification configuration from the plurality of random access occasion identification configurations.

Aspect 8: The method of any of aspects 1 through 7, wherein obtaining the information comprises: obtaining, via the information, an indication that the UE is to use the random access occasions in the SBFD symbols.

Aspect 9: The method of aspect 8, further comprising: refraining from transmitting the one or more random access preambles during the other random access occasions of the plurality of random access occasions based at least in part on obtaining the indication via the information, wherein the one or more random access preambles are transmitted only during the one or more random access occasions of the SBFD symbol based at least in part on obtaining the indication via the information.

Aspect 10: The method of any of aspects 8 through 9, further comprising: receiving a control message that indicates a reference signal prioritization, wherein the one or more random access preambles are transmitted during the one or more random access occasions of the SBFD symbol or during the other random access occasions of the plurality of random access occasions based at least in part on the reference signal prioritization and on obtaining the indication via the information.

Aspect 11: The method of any of aspects 8 through 10, further comprising: transmitting the one or more random access preambles only during the one or more random access occasions of the SBFD symbol based at least in part on the UE satisfying one or more thresholds and on obtaining the indication via the information.

Aspect 12: The method of aspect 11, wherein the one or more thresholds comprise a reference signal received power threshold, a transmission power threshold, or a combination thereof.

Aspect 13: The method of any of aspects 1 through 12, wherein obtaining the information comprises: identifying that the information of whether the UE is to use the random access occasions in the SBFD symbols is associated with a subset of UE-specific random access configurations of the one or more UE-specific random access configurations.

Aspect 14: The method of any of aspects 1 through 13, further comprising: receiving, via a bit of a control message, the information that is indicative of whether the UE is to use the random access occasions in the SBFD symbols, the bit of the control message comprising an indication of the information, wherein obtaining the information is based at least in part on receiving the control message, and wherein the control message is triggered via a control channel order.

Aspect 15: The method of aspect 14, further comprising: selecting a random access occasion for transmitting the one or more random access preambles, wherein the random access occasion is selected from a pool of respective random access occasions that are available for transmission of the one or more random access preambles.

Aspect 16: The method of any of aspects 14 through 15, wherein the control message is a DCI message, an RRC message, or a combination thereof.

Aspect 17: The method of any of aspects 1 through 16, further comprising: identifying whether the UE is configured with a first random access procedure or a second random access procedure, wherein the information that is indicative of whether the UE is to use the random access occasions in the SBFD symbols is obtained based at least in part on identifying that the UE is configured with a respective random access procedure.

Aspect 18: The method of aspect 17, wherein the first random access procedure is a contention based random access procedure and the second random access procedure is a contention free random access procedure.

Aspect 19: A method for wireless communications by a network entity, comprising: transmitting, to a UE, one or more UE-specific random access configurations each associated with respective random access-triggering events, the one or more UE-specific random access configurations each indicative of a plurality of random access occasions for random access; transmitting, to the UE, information that is indicative of whether the UE is to use random access occasions in SBFD symbols; and receiving, from the UE, one or more random access preambles during one or more random access occasions of a SBFD symbol or during other random access occasions of the plurality of random access occasions based at least in part on whether the UE is to use the random access occasions in the SBFD symbols.

Aspect 20: The method of aspect 19, further comprising: transmitting, to the UE via a control message, the information that is indicative of whether the UE is to use the random access occasions in the SBFD symbols, wherein the one or more random access preambles are received during the one or more random access occasions of the SBFD symbol based at least in part on transmitting the control message.

Aspect 21: The method of aspect 20, wherein the control message includes a parameter whose value is a configuration index that indicates the information.

Aspect 22: The method of any of aspects 20 through 21, wherein the control message indicates that the UE is not configured to use the random access occasions in the SBFD symbols based at least in part on an absence, in the control message, of a parameter whose value is a configuration index that, when present, indicates the information.

Aspect 23: The method of any of aspects 20 through 22, wherein the control message is a RRC message.

Aspect 24: The method of any of aspects 19 through 23, wherein transmitting the information comprises: transmitting, to the UE, an indication to use a random access occasion identification configuration from a plurality of random access occasion identification configurations, the plurality of random access occasion identification configurations comprising a first random access occasion identification configuration for identifying only the other random access occasions of the plurality of random access occasions, a second random access occasion identification configuration for identifying the other random access occasions of the plurality of random access occasions and the one or more random access occasions of the SBFD symbol, and a third random access occasion identification configuration for identifying only the one or more random access occasions of the SBFD symbol.

Aspect 25: The method of aspect 24, wherein the one or more UE-specific random access configurations associated with the respective random access-triggering events comprise an indication of a default random access occasion identification configuration from the plurality of random access occasion identification configurations.

Aspect 26: The method of any of aspects 19 through 25, wherein transmitting the information comprises: transmitting, to the UE, an indication configuring the UE to use the random access occasions in the SBFD symbols.

Aspect 27: The method of aspect 26, further comprising: receiving, from the UE, the one or more random access preambles only during the one or more random access occasions of the SBFD symbol based at least in part on transmitting the indication via the information.

Aspect 28: The method of any of aspects 26 through 27, further comprising: transmitting, to the UE, a control message that indicates a reference signal prioritization, wherein the one or more random access preambles are received during the one or more random access occasions of the SBFD symbol or during the other random access occasions of the plurality of random access occasions based at least in part on transmitting the reference signal prioritization and on transmitting the indication via the information.

Aspect 29: The method of any of aspects 26 through 28, further comprising: receiving, from the UE, the one or more random access preambles only during the one or more random access occasions of the SBFD symbol based at least in part on the UE satisfying one or more thresholds and on transmitting the indication via the information.

Aspect 30: The method of aspect 29, wherein the one or more thresholds comprise a reference signal received power threshold, a transmission power threshold, or a combination thereof.

Aspect 31: The method of any of aspects 19 through 30, wherein transmitting the information comprises: transmitting, to the UE, an indication that the information of whether the UE is to use the random access occasions in the SBFD symbols is associated with a subset of UE-specific random access configurations of the one or more UE-specific random access configurations.

Aspect 32: The method of any of aspects 19 through 31, further comprising: transmitting, to the UE via a bit of a control message, the information that is indicative of whether the UE is to use the random access occasions in the SBFD symbols, the bit of the control message comprising an indication of the information, wherein transmitting the information is based at least in part on transmitting the control message, and wherein the control message is triggered via a control channel order.

Aspect 33: A UE for wireless communications, comprising one or more memories storing processor-executable code, and one or more processors coupled with the one or more memories and individually or collectively operable to execute the code to cause the UE to perform a method of any of aspects 1 through 18.

Aspect 34: A UE for wireless communications, comprising at least one means for performing a method of any of aspects 1 through 18.

Aspect 35: A non-transitory computer-readable medium storing code for wireless communications, the code comprising instructions executable by one or more processors to perform a method of any of aspects 1 through 18.

Aspect 36: A network entity for wireless communications, comprising one or more memories storing processor-executable code, and one or more processors coupled with the one or more memories and individually or collectively operable to execute the code to cause the network entity to perform a method of any of aspects 19 through 32.

Aspect 37: A network entity for wireless communications, comprising at least one means for performing a method of any of aspects 19 through 32.

Aspect 38: A non-transitory computer-readable medium storing code for wireless communications, the code comprising instructions executable by one or more processors to perform a method of any of aspects 19 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more UE-specific random access configurations each associated with respective random access-triggering events, the one or more UE-specific random access configurations each indicative of a plurality of random access occasions for random access;
obtain information that is indicative of whether the UE is to use random access occasions in subband full duplex symbols; and
transmit one or more random access preambles during one or more random access occasions of a subband full duplex symbol or during other random access occasions of the plurality of random access occasions based at least in part on the information.

2. The UE of claim 1, wherein the one or more processors are individually or collectively further operable to execute the code to cause the UE to:
receive, via a control message, the information that is indicative of whether the UE is to use the random access occasions in the subband full duplex symbols, wherein obtaining the information is based at least in part on receiving the control message.

3. The UE of claim 2, wherein the control message includes a parameter whose value is a configuration index that indicates the information.

4. The UE of claim 2, wherein the control message indicates that the UE is not configured to use the random access occasions in the subband full duplex symbols based at least in part on an absence, in the control message, of a parameter whose value is a configuration index that, when present, indicates the information.

5. The UE of claim 2, wherein the control message is a radio resource control message.

6. The UE of claim 1, wherein, to obtain the information, the one or more processors are individually or collectively operable to execute the code to cause the UE to:
obtain an indication to use a random access occasion identification configuration from a plurality of random access occasion identification configurations, the plurality of random access occasion identification configurations comprising a first random access occasion identification configuration for identifying only the other random access occasions of the plurality of random access occasions, a second random access occasion identification configuration for identifying the other random access occasions of the plurality of random access occasions and the one or more random access occasions of the subband full duplex symbol, and a third random access occasion identification configuration for identifying only the one or more random access occasions of the subband full duplex symbol.

7. The UE of claim 6, wherein the one or more UE-specific random access configurations associated with the respective random access-triggering events comprise an indication of a default random access occasion identification configuration from the plurality of random access occasion identification configurations.

8. The UE of claim 1, wherein, to obtain the information, the one or more processors are individually or collectively operable to execute the code to cause the UE to:
obtain, via the information, an indication that the UE is to use the random access occasions in the subband full duplex symbols.

9. The UE of claim 8, wherein the one or more processors are individually or collectively further operable to execute the code to cause the UE to:
refrain from transmitting the one or more random access preambles during the other random access occasions of the plurality of random access occasions based at least in part on obtaining the indication via the information, wherein the one or more random access preambles are transmitted only during the one or more random access occasions of the subband full duplex symbol based at least in part on obtaining the indication via the information.

10. The UE of claim 8, wherein the one or more processors are individually or collectively further operable to execute the code to cause the UE to:
receive a control message that indicates a reference signal prioritization, wherein the one or more random access preambles are transmitted during the one or more random access occasions of the subband full duplex symbol or during the other random access occasions of the plurality of random access occasions based at least in part on the reference signal prioritization and on obtaining the indication via the information.

11. The UE of claim 8, wherein the one or more processors are individually or collectively further operable to execute the code to cause the UE to:
select, based at least in part on the UE satisfying one or more thresholds, the one or more random access occasions of the subband full duplex symbol; and
transmit the one or more random access preambles only during the one or more random access occasions of the subband full duplex symbol based at least in part on the UE selecting the one or more random access occasions and on obtaining the indication via the information.

12. The UE of claim 11, wherein the one or more thresholds comprise a reference signal received power threshold, a transmission power threshold, or a combination thereof.

13. The UE of claim 1, wherein, to obtain the information, the one or more processors are individually or collectively operable to execute the code to cause the UE to:
identify that the information of whether the UE is to use the random access occasions in the subband full duplex symbols is associated with a subset of UE-specific random access configurations of the one or more UE-specific random access configurations.

14. The UE of claim 1, wherein the one or more processors are individually or collectively further operable to execute the code to cause the UE to:
receive, via a bit of a control message, the information that is indicative of whether the UE is to use the random access occasions in the subband full duplex symbols, the bit of the control message comprising an indication of the information, wherein obtaining the information is based at least in part on receiving the control message, and wherein the control message is triggered via a control channel order.

15. The UE of claim 14, wherein the one or more processors are individually or collectively further operable to execute the code to cause the UE to:
select a random access occasion for transmitting the one or more random access preambles, wherein the random access occasion is selected from a pool of respective random access occasions that are available for transmission of the one or more random access preambles.

16. The UE of claim 14, wherein the control message is a downlink control information message, a radio resource control message, or a combination thereof.

17. The UE of claim 1, wherein the one or more processors are individually or collectively further operable to execute the code to cause the UE to:
identify whether the UE is configured with a first random access procedure or a second random access procedure, wherein the information that is indicative of whether the UE is to use the random access occasions in the subband full duplex symbols is obtained based at least in part on identifying that the UE is configured with a respective random access procedure.

18. The UE of claim 17, wherein the first random access procedure is a contention based random access procedure and the second random access procedure is a contention free random access procedure.

19. A network entity, comprising:
one or more memories storing processor-executable code; and
one or more processors coupled with the one or more memories and individually or collectively operable to execute the code to cause the network entity to:
transmit, to a user equipment (UE), one or more UE-specific random access configurations each associated with respective random access-triggering events, the one or more UE-specific random access configurations each indicative of a plurality of random access occasions for random access;
transmit, to the UE, information that is indicative of whether the UE is to use random access occasions in subband full duplex symbols; and
receive, from the UE, one or more random access preambles during one or more random access occasions of a subband full duplex symbol or during other random access occasions of the plurality of random access occasions based at least in part on whether the UE is to use the random access occasions in the subband full duplex symbols.

20. A method for wireless communications by a user equipment (UE), comprising:
receiving one or more UE-specific random access configurations each associated with a random access-triggering event, the one or more UE-specific random access configurations each indicative of a plurality of random access occasions for random access;
obtaining information that is indicative of whether the UE is to use random access occasions in subband full duplex symbols; and
transmitting one or more random access preambles during one or more random access occasions of a subband full duplex symbol or during other random access occasions of the plurality of random access occasions based at least in part on the information.
